(19) United States
(12) Patent Application Publication
(10) Pub. No.: US 2002/0178062 A1
(43) Pub. Date: Nov. 28, 2002

(54) Flexible, orienting, and better shopping wallet for netizens

(76) Inventors: Delores M. Wright, Rochester, MN (US); Nornan Wilson, Rochester, MN (US)

Correspondence Address: LAW OFFICES OF MICHAEL DRYJA, 704 228TH AVENUE NE, PMB 694, SAMMAMISH, WA, 98074, US

(21) Appl. No.: 09/768,694

(22) Filed: Jan. 24, 2001

Related U.S. Application Data
(60) Provisional application No. 60/177,682, filed on Jan. 24, 2000.

(51) Int. Cl. G06F 17/60

(52) U.S. Cl. 705/17

(57) ABSTRACT

An inventive electronic wallet management method is disclosed. It enables the wallet to be stored on a server, on a server access device or on a portable medium with full version control. It allows data to be entered into the wallet on the server access device or onto the server to maximize user convenience.

### BACKGROUND OF THE INVENTION

The Flexible, Orienting, and Better Shopping Wallet for Netizens is a method of solving four problems experienced by netizens of the global Internet village: the Orientation, Identification, Ergonomic, and Shopping problems.

The Netizen Orientation Problem:

A netizen currently feels disoriented within the global Internet village. In the off-line world she makes friendships and alliances and has a mental map of her relationships and keeps updating it to reflect daily events. In the global Internet village she also needs to know the state of play as regards her relationships: who she has told what to; who is thinking what about her; who is saying what about her to whom; and what contracts she has made with whom. She is, however, not so well equipped to make a mental map of online relationships, since her sensory memories are impoverished compared with off-line.

The Netizen Identification Problem:

A netizen's orientation in the global Internet village is greatly assisted, if, when she visits a site that she has visited before, the site recognizes her. And a site is able to be more helpful to the netizen, if it knows about its past interactions with her. To achieve these benefits, it is necessary for the netizen to have a unique identifier within the database of each site that she visits. The site can then ‘remember’ the state of play with that netizen by recording data against her unique identifier. Currently one problem for a netizen that visits many sites is that, since she may have more than one identifier, it is difficult for her to recall which one, if any, applies to a given site. She may try to avoid this problem by using the same identifier on all sites. However this may not be possible, because what is unique within one site may not be unique across all sites.

The Netizen Ergonomic Problem:

Many interactions between a netizen and an Internet site require her to give the site some personal data, e.g. delivery name and address and bankcard details. When she visits a new site the same details may be required again and she has to enter them yet again. This is a waste of time and energy and can lead to transcription errors.

The Netizen Shopping Problems:

Currently when shopping on sites using catalogues, the prices are not converted into the currency that suits her when she is importing and when she is buying on the home market and the product names and descriptions are not supplied in her preferred language. She cannot elect to either shop on her own behalf or on behalf of an organization—each site specializes in one or the other. She cannot make charitable donations by assigning bonus points earned by her purchases to one or more organizations of her choice, including the one on whose behalf she is shopping. If her shopping is interrupted, she cannot return to a site and expect to find her shopping basket just as she left it. At best she can mark some items “save until later” at checkout stage. To have the contents of her basket delivered to more than one address, she must select an address for each item in her basket. She is not told how much any import duty will be before she confirms her order. She has no facility for forward ordering. No site splits an order line if some of the items for the line are not in stock. She cannot split an order line if she wishes to use more than one transit method for the items in the line. She cannot split an order line if she wants to use more than one gift wrap style for the items in it. The gift wrap price is not varied with the size of the item or the quality of the wrapping. No site calculates carriage in real time for any destination. She cannot shop and view the contents of her basket at the same time. She cannot amend her basket at any time before paying. She cannot pay for the various sub-sections of her basket with different bankcards. She does not have the option of paying by bankcard or via a company account. She cannot arrange to make returns or check up on returns she has already made by interacting online with the site. She cannot arrange for import duty to be paid when the goods arrive in the destination country without further intervention on her part. She cannot archive her wallet data to prevent the wallet becoming unnecessarily large. Each of these deficiencies is a loss of convenience to the netizen.

Furthermore she has to communicate with the site server at every stage of purchasing: getting thumbnails of the products in the catalogue, getting the details for a selected thumbnail, putting an item in her shopping basket, viewing and modifying the contents of her basket, continuing to shop or proceeding to checkout, supplying delivery details, selecting transit method, gift wrapping, getting carriage costs and customs duties payable, getting bank card authorization. This means that shopping is slower than necessary and that the site server is carrying out these tasks instead of making more sales.

Currently there are two methods used to solve the first three problems, the Orientation, Identification and Ergonomic problems, described above. These methods are known respectively as the server-side wallet and the client-side wallet.

In both cases a netizen uses an Internet Access Device (IAD), (at present this is usually a personal computer), to access a registry site. On this site she enters an identifier (User Name and Password) that is unique within the registry. In both cases this registration enables her to download some software to the fixed data storage facility of her IAD.

A description of the rest of the client-side wallet method follows:

1. The IAD Software downloaded to the client IAD places a wallet icon in her web browser and on her IAD desktop. She can activate the first icon at the beginning of a web session: it allows her to enter her registry identifier and it uses this identifier to locate her wallet on her IAD whenever it is required during the web session. She can activate the second icon on her desktop outside a web session. This icon enables the netizen to create, update, and delete personal data in her wallet on her IAD.

2. The Wallet Management Software downloaded to the client IAD contains a database structure and processes that support the entry to and retrieval of personal data, e.g. names, addresses, and bankcard details, and also order details from this database.

3. For occasions when the netizen visits a site that is not a member of the registry scheme the IAD Software reduces the amount of form-filling that the netizen is required to do:

a. it reads the code composing a web page to identify any field labels that it may contain

b. it searches the database for data associated with each such label

c. it displays the data found for a field label as a list from which the netizen can choose one datum (a single address counts as one datum)

d. it displays the chosen datum within the associated field on the web page

e. if the netizen indicates that she does not wish to use any of the items on the list and instead keys the datum into the field herself, it records the datum entered together with the field label within the database, so that it is available for future use

It automatically copies any order or donation details that she makes on the site page and stores it in an unstructured format in the wallet database on her IAD.

4. For occasions when the netizen visits a site that is a member of the registry scheme the IAD Software reduces the amount of form-filling that the netizen is required to do in that such a site presents no forms to netizens that have registry wallets. In this situation if the member site needs an item of personal data from the netizen and the netizen has opened her wallet, it will

a. search the database for a datum associated with a standard label for that item

b. display the data found for a field label as a list from which the netizen can choose one datum (an address counts as one datum)

c. display the chosen datum on the web page

d. display a wallet form into which she can key the datum required, if the netizen indicates that she does not wish to use any of the items on the list

e. record the datum entered within the database, so that it is available for future use

f. automatically enters any order or donation that she makes on the site as structured data into her wallet database on her IAD.

A server-side wallet functions exactly like a client-side wallet except that the wallet database and the processes that create, update, delete, and retrieve data from it remain on the server.

Both the client-side and server-side wallet methods solve the netizen's orientation problem to some extent by noting within her wallet what purchases or donations the netizen has made. Neither, however, holds within her wallet either a complete audit trail regarding what personal data she has given to which sites or all that each member site has recorded about her on its database.

Both wallet methods solve the netizen's identification problem. She enters her registry identifier once per web session. For member sites this is all she has to do. For a non-member site, she still has to remember her site identifier once more, so that her wallet can capture it. After this she only has to remember and use her registry identifier in order to open her wallet. Her wallet enters any other identifiers required by sites she visits.

Both wallet methods solve the ergonomic problem as far as possible by allowing the netizen to store the data required by sites in her wallet. This data is entered into her wallet via a wallet form or via non-member site forms. Non-member sites can save the netizen a great deal of time and energy by using standard field labels in their page code.

A client-side wallet has many advantages compared with a server-side wallet:

1. Inexpensive data storage: As the variety of Internet services offered on the Internet increases, so the variety of types of personal data required by the Internet sites also increases. There is currently a widespread need for billing and delivery addresses plus bankcard details. In the future, sites will be asking for, e.g., a netizen's dimensions, weight, health record, insurance details, drivers license details, and so on. As the Internet develops, the cost of storing, backing up, and making permanently available each netizen's server-side wallet will increase. By contrast as the amount of personal data needed increases, a client-side wallet increases in size at an insignificant incremental cost to the netizen and at no cost to the registry.

2. Inexpensive Access: As more and more netizens (potentially 6 billion and rising) want to access their server-side wallets, the cost of preventing unacceptable access bottlenecks will increase. By contrast, if all netizens have client-side wallets, as the number of netizens increases, the registry of unique identifiers grows, but this does not cause any access bottlenecks. This is because the netizens need only access the registry's central server in order to register and after this, neither they nor the sites they visit ever need to access the registry site.

3. Inexpensive Audit Trail: If a server-side wallet were to hold a complete audit trail of netizen's dealings on the Internet and a copy of each site's data about her, rather than just a list of her purchases or donations, this would further increase storage costs. By contrast the client-side wallets can contain all of this without any increase in storage cost to the registry and with insignificant increase in such cost to the netizen.

4. Fast Access: If the netizen wishes to access her server-side wallet to study the data held in it, she must log on to the Internet and visit the Qpass site. By contrast a netizen with a client-side wallet need not log on to the Internet, so access to her data is faster. Similarly, if data is to be retrieved from her wallet during a web session the retrieval time is much shorter if the wallet is client-side than if it is server-side.

5. Safety: From the netizen's point of view, the most serious disadvantage of a server-side wallet is that her personal data is not under her control; it is out there somewhere in cyber space along with millions of other wallets—a tempting, concentrated target for hackers. By contrast client-side wallets are dispersed and each one remains under the control of the netizen on the local storage medium of her IAD.

The client-side wallet suffers, however, from two disadvantages not shared by the server-side wallet:

1. If the IAD is a “thin client”, i.e. it has little local intelligence and/or local data storage facility, then a server-side wallet is required and a client-side wallet cannot be used.

2. The netizen cannot use her client-side wallet from any IAD. Physically a client-side wallet could be copied from one IAD (A) to another IAD (B) in one of two ways:

a. by copying the wallet from (A) onto a diskette (a mobile data storage medium) and then copying it from the diskette onto (B)

b. by uploading the wallet from (A) onto an Internet server and downloading it from this Internet server onto (B)

However, since the wallet may be updated every time it is used, such a practice could place a different version of her wallet on each IAD that she uses. This is chaotic since, e.g. each may have a different and incomplete record of her purchases and each may have different and conflicting sets of personal data.

Currently netizens have to choose to have a client-side wallet or a server-side wallet. Alternatively she can choose to have one of each and maintain two wallets. She cannot have one wallet and choose its location according to her situation—there is no flexible wallet.

### BRIEF SUMMARY OF THE INVENTION

The Flexible, Orienting, and Better Shopping Wallet for Netizens is a new method of solving the netizen's orientation, identification, ergonomic, and shopping problems: it allows the netizen to choose every time she opens a web-session whether to operate her wallet as a server-side wallet or a client-side wallet during that session. At the end of each wallet session she can choose where to store her wallet: server-side or client-side. If she chooses to store it client-side, she can choose whether to make it portable or not. If she chooses to make it portable, then she can specify which sections of her wallet are to be portable. The current invention enables her to keep her options open and to adapt her wallet to suit her situation—it provides her with a flexible wallet.

Furthermore the Flexible, Orienting, and Better Shopping Wallet for Netizens method provides full Orientation for the netizen within the global Internet village:

a. it keeps a complete audit trail for her web sessions

b. it records orders and donations

c. it captures from any site visited by the netizen any other data held about her on that site's database, if the site is a member of the wallet registry's scheme

d. it archives the audit trail regularly to prevent the Flexible Wallet from becoming too bloated

e. It uses the natural language preferred by the netizen.

The Flexible, Orienting, and Better Shopping Wallet for Netizens method

1. allows the netizen to run a server-side wallet; this has disadvantages as regards cost, speed, and safety but

a. ensures that she will never to be caught on her travels without her wallet

b. allows her to use an IAD that can only support a thin client

c. allows her to avoid putting her wallet on an IAD that may be a security risk for her

2. allows her to run a client-side wallet; in this mode she gets the advantages of safe, cheap storage, and fast access and

a. she can convert this client-side wallet into a portable one, so that she can use it on her travels

b. if she chooses to port her wallet (via a diskette or other mobile storage medium), then she must be careful not to lose it. However, if she does lose it, she can retrieve it from the last IAD that she used

3. if she wishes to use her wallet on an IAD and she has no access to her wallet, the registry automatically provides a temporary server-side wallet which gets amalgamated with her permanent wallet at the first opportunity

4. allows shopping at a site that uses the catalogue method of selling goods to be handled largely on the client; this gives the advantage of fast response times to the purchasing process; this is also economical as regards use of the site server.

Furthermore the current invention achieves portability without chaos for the netizen's wallet:

1. It treats the diskette version as the wallet and ignores the fact that different versions of it may exist on each IAD used by the netizen.

2. Whenever she inserts the diskette wallet into an IAD and clicks her wallet browser button, if there is a copy of her wallet on the fixed storage medium of that IAD and the netizen supplies a diskette wallet to the IAD's diskette reader the diskette wallet is automatically integrated with the copy on the IAD; if there is no copy on the IAD, but the netizen submits her diskette wallet to the IAD, the contents of the diskette are copied to the IAD.

3. If there is a copy of her wallet on both the client and the server, these are automatically synchronized.

4. If, for some reason, she creates more than one portable wallet and they are different versions, they can be amalgamated into one by presenting each one in turn for separate web sessions on a single IAD. The procedure is the same for any number of diskette wallets: they can all be reduced to one authoritative wallet in this manner.

The current invention also provides the netizen with better shopping because, whether her wallet database is currently located server-side or client-side, the wallet method includes software that is permanently resident client-side on the IAD and which is used by any number of wallets. This software, located on the IAD, can carry out the following tasks with minimal reference to the server of the site on which she is shopping:

Netizen Preferences

1. Determine from the netizen's wallet her preferred currencies for the home market and for importing. Their names are automatically submitted to the site she is visiting so that it can present prices in her preferred currency; this facility makes the netizen feel more at home and enables her to manage her budgets since her bank accounts are likely to be in these currencies.

2. Determine from the netizen's wallet her preferred language and automatically submit its name to the site she is visiting so that it can present product descriptions in her preferred language.

Organizations

1. Allow the netizen, on each visit to a site, to elect to represent an organization or to shop on her own behalf. The IAD software consults the site for a list of organizations that she is authorized to represent on the current site. She can then choose one of these. This means that one site can serve both consumers and businesses.

2. Accumulate bonus points to be donated to organizations chosen by the netizen this encourages altruism and helps charities.

Multi-tasking and Continuity

1. Allow the netizen to continue shopping while still being able to view her shopping basket contents

2. Retain a basket which has not completed the check-out procedure after the netizen has left the site, so that the netizen can come back to it without having to request for each individual item that it be “saved until later”. This saves the netizen having to start over again, should she exit the site before completing and confirming her order.

3. Allow the netizen to view one shopping basket for each of several sites at the same time—this makes comparison shopping easier.

4. Allow the netizen to leave a site on which she has been shopping without losing her shopping basket, go to another site, shop on this other site and compare the contents of the two shopping baskets and so on for any number of sites and baskets. This is convenient for comparison shopping.

5. Allow the netizen on a given site to amalgamate an old basket that did not complete the checkout procedure with the current basket for the site.

6. Allow the netizen to amend her basket at any time before it has been transmitted to the site as a confirmed order.

Destination Flexibility

1. Allow the netizen to assign several delivery addresses to one basket by assigning each order line to one address (splitting the order lines only where necessary). This means that she can select each delivery address only once, rather than once for each line in the delivery.

Dispatch Delay Flexibility

1. Allow the site to split an order line if not all the items in it have the same dispatch delay.

2. Splits a delivery into sub-deliveries, whenever the site reports more than one dispatch delay for order lines within a delivery.

3. Allows the netizen to lengthen the dispatch delays supplied by the site as a way of forward ordering.

Transit Method Flexibility

1. Allows the netizen to select a transit method for each order line in her basket within the limits of what is permissible for the type of product.

2. Allows the netizen to split a delivery into sub-deliveries, whenever the transit methods she wishes to use are not applicable to all the items in a delivery.

3. Allows the netizen to split an order line, whenever a transit method she wishes to use is not to be applied to all the items in the line.

Carriage Charges Flexibility

1. Provide the netizen, after consulting a specialized Carriage and Tariffs Server, with carriage costs no matter what the destination.

2. Provide the netizen, after consulting a specialized Carriage and Tariffs Server, with the lowest carriage costs for each transit method (presented as journey durations) she has selected for each delivery or sub-delivery composing her shopping basket.

3. If the netizen does not want to accept the charges she can select a different set of transit methods and get these priced and so on until she is ready to accept the transit charges.

In this way the netizen makes informed decisions about which transit method to use, if any, for which sub-delivery.

Gift Wrapping Flexibility

1. Allows the netizen to select a different gift wrap style for each item in each order line in the netizen's basket.

2 Calculates a gift wrap price tailored to the amount of paper used and the quality of the gift wrap.

Support for Importing

3. Tell the netizen, after consulting a specialized Carriage and Tariffs Server, when she is shopping across trading zone boundaries and the rules about paying import duty for this particular boundary.

4. Allow the netizen to enter the tariff code for each order line in her shopping basket, if necessary, and then calculate the import duty payable for each of these lines.

5. Allow the netizen to arrange to have any import duty paid via the Internet to the relevant Customs and Excise when the goods arrive at their destination country without any further intervention by her.

This means that world trade and the increase in wealth that follows from such trade is supported by this invention.

Payment Flexibility

1. Allow the netizen to pay by bankcard or, if she is representing an organization, to use a company account.

2. Allow the netizen to select which sub-deliveries are to be paid for by which method.

3. Allow the netizen to select which sub-deliveries should be paid for from which bankcard or which company account.

4. The registry credits the Customs and Excise bank account with any import duty that is due when goods arrive at the boundary of the country and debits the bankcard or, if no bankcard is involved, the site bank account. Again this reduces the load on the site servers.

Returns Management

1. Allow the safe arrival of returns to be verified by the netizen

2. Allow the netizen to warn the site of impending returns for which the site issues a return identifier. This means better customer service.

Advantages for Member Sites

1. Instead of communicating with the site server at every stage of purchasing, the IAD only consults the site server to authorize a netizen as a representative of an organization, a provider of a catalogue of products described in many languages, of dispatch delays, of gift wrap styles, and of account authorization.

2. The site server does not have to manage the shopping process which means that it can concentrate on customer sales support, providing a good catalog, and the business of fulfillment. It can concentrate on these with the assurance that only when the order is confirmed and complete in all respects is it transmitted to the site which sets about fulfilling the order.

3. As soon as it dispatches a sub-delivery it notifies the registry server that the dispatch has occurred:

If the dispatch is to be paid for by bankcard, the registry credits the site bank account with the total amount due for the dispatch (less insurance and import duty) less an agreed payment to the registry and debits the bankcard.

If an organization account is to be used, the registry sends an invoice to the organization. When the site receives a payment on the account, it notifies the registry and the registry debits the site with the agreed payment to the registry.

This means that the accounting work of the site is greatly reduced.

4. The registry credits an insurer with any premiums due for a dispatch as soon as it is notified of the dispatch and debits the bankcard or, if no bankcard is involved, the site bank account. Again this reduces the load on the site servers.

5. The use of a specialist site to determine import duty and carriage saves endless duplication of these functions for every site.

### DETAILED DESCRIPTION OF THE INVENTION

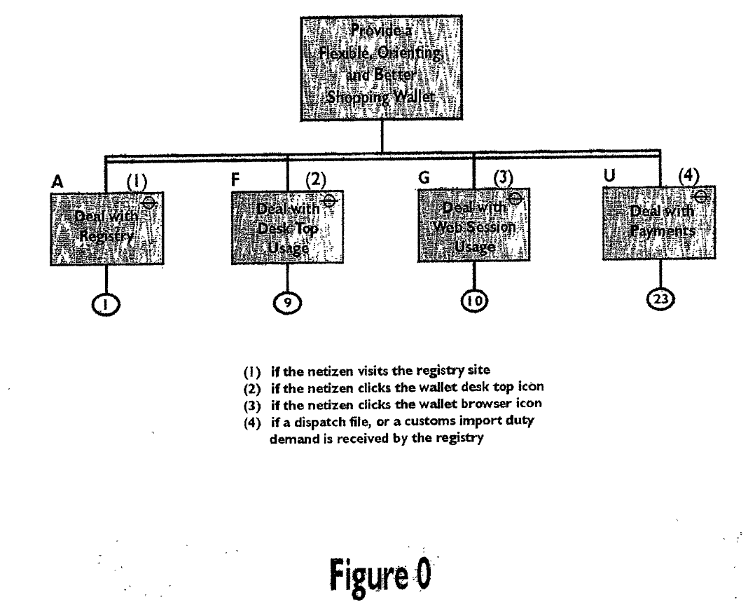

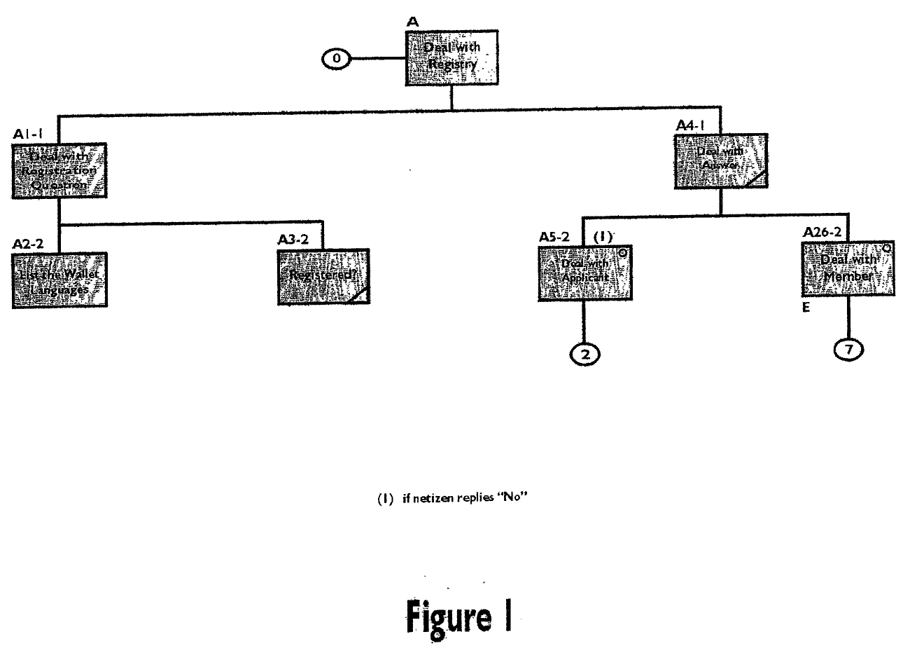

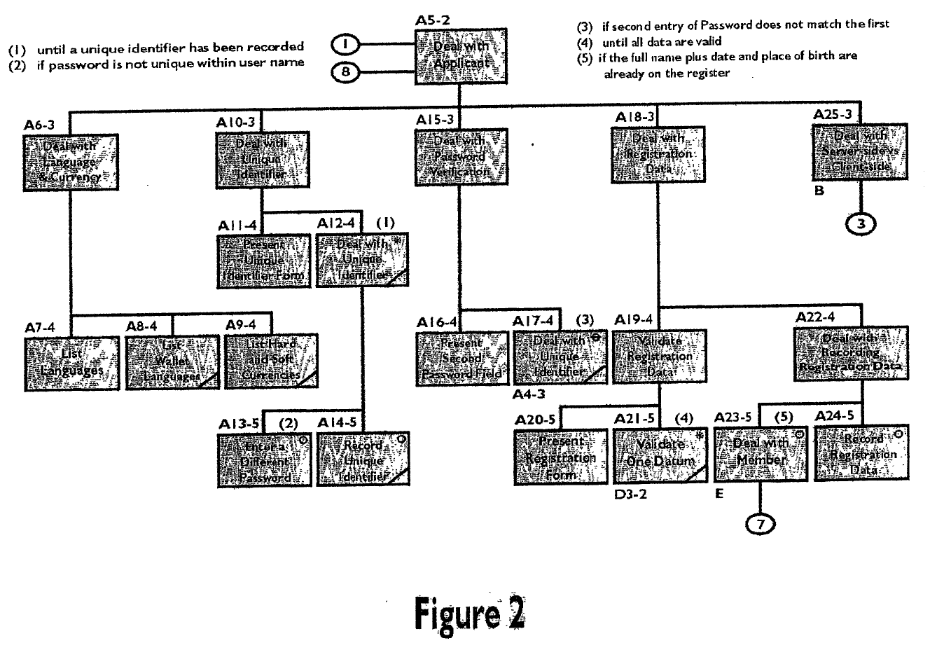

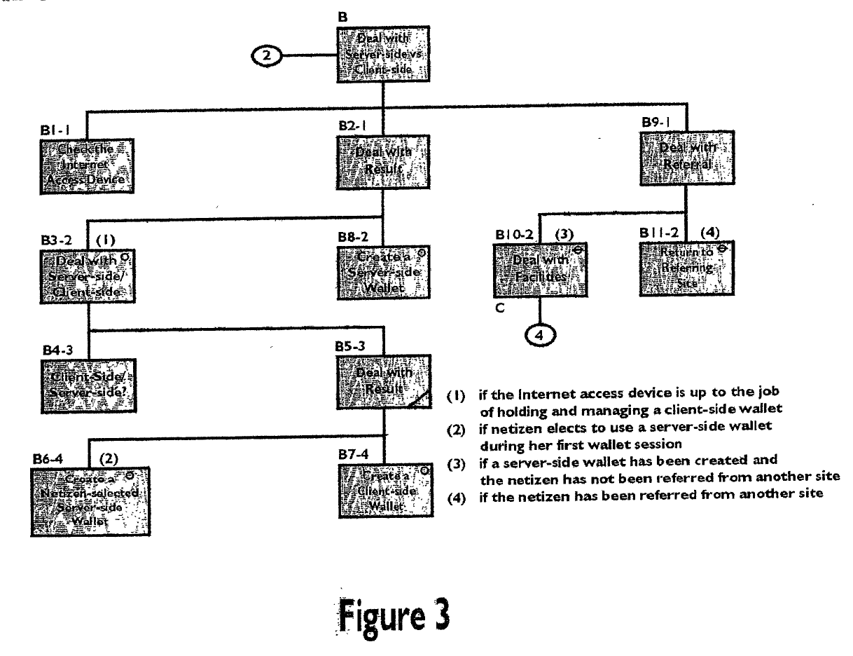

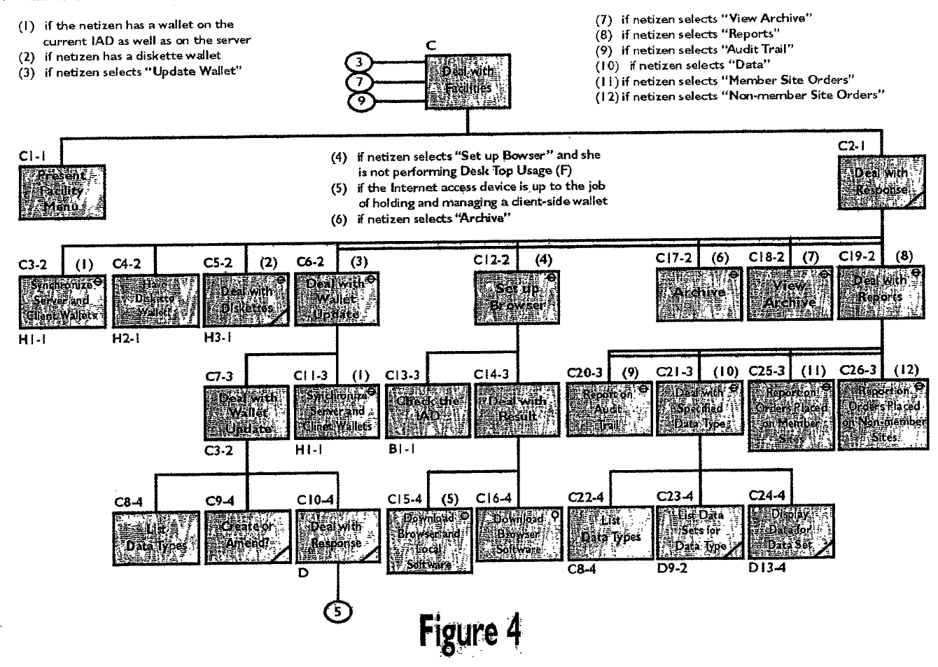

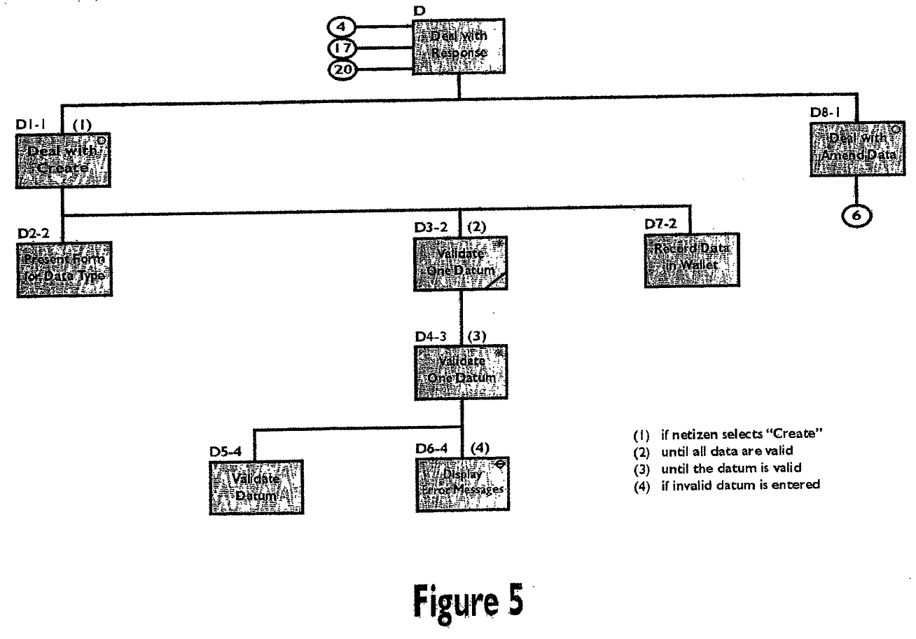

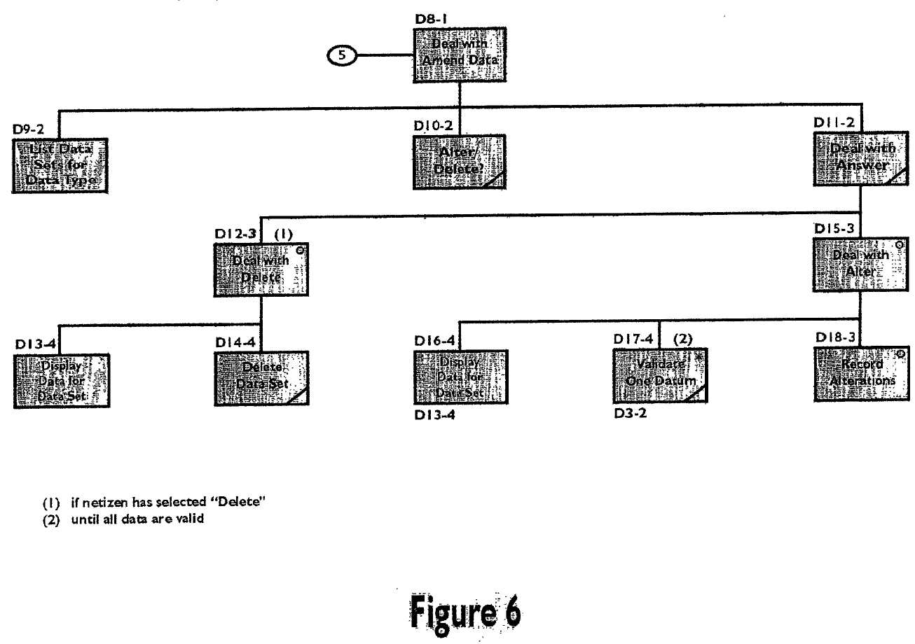

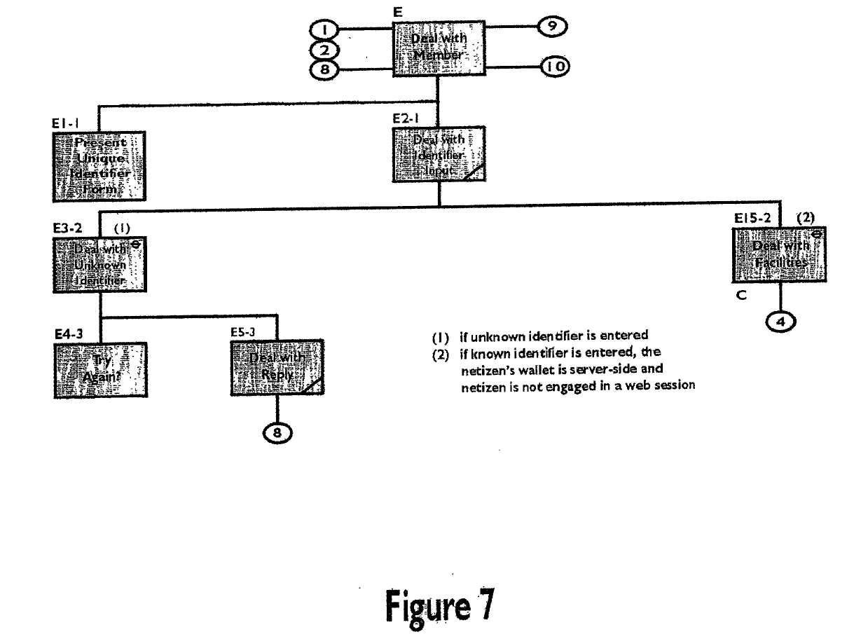

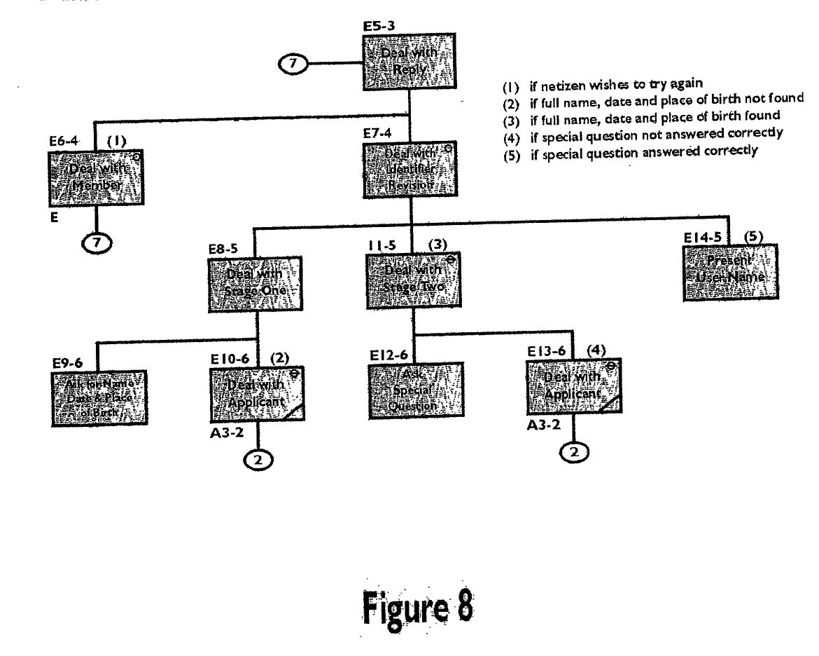

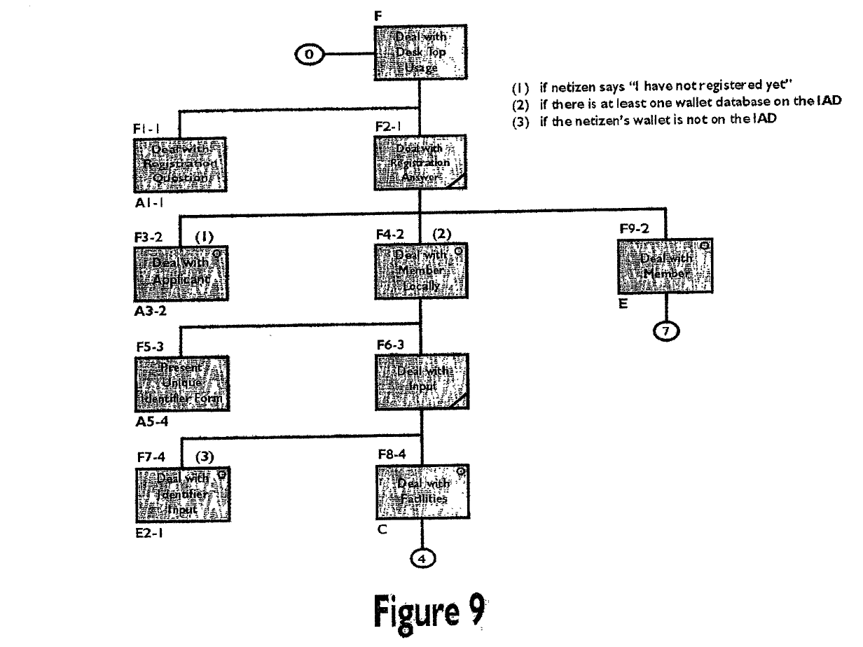

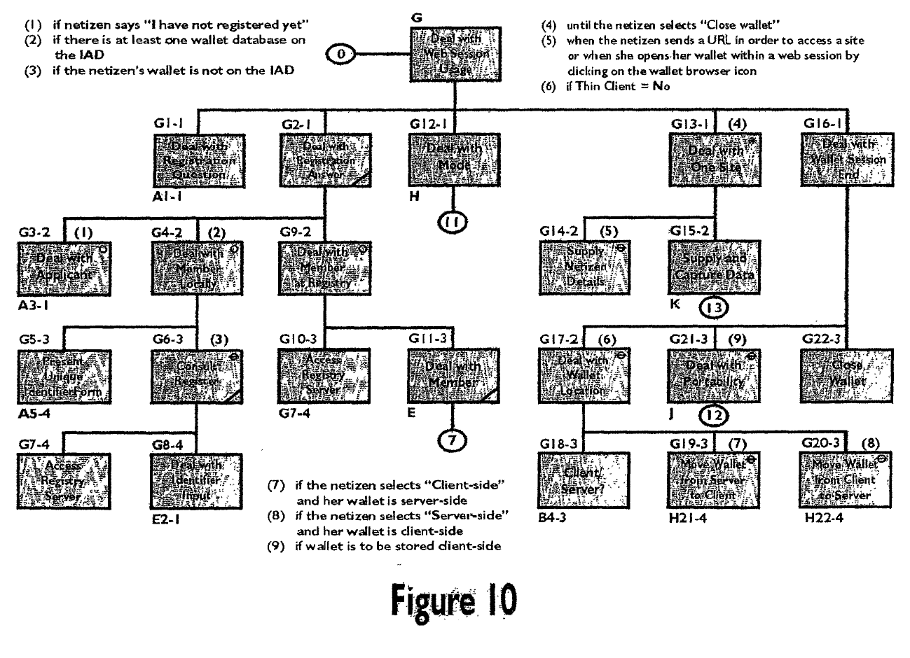

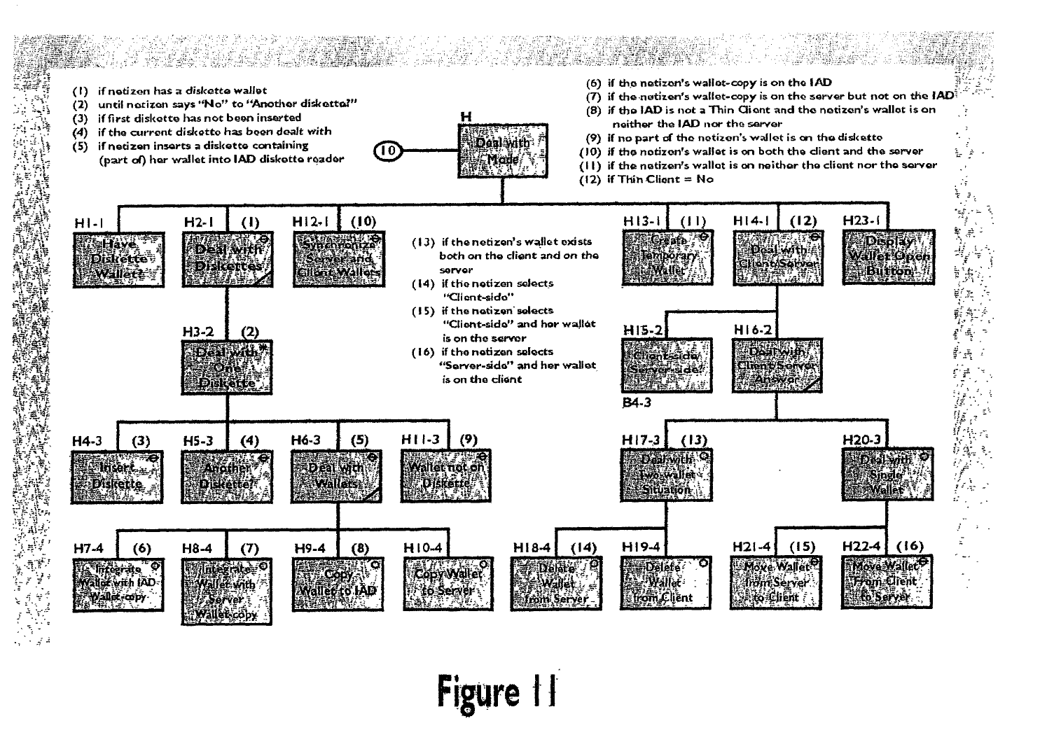

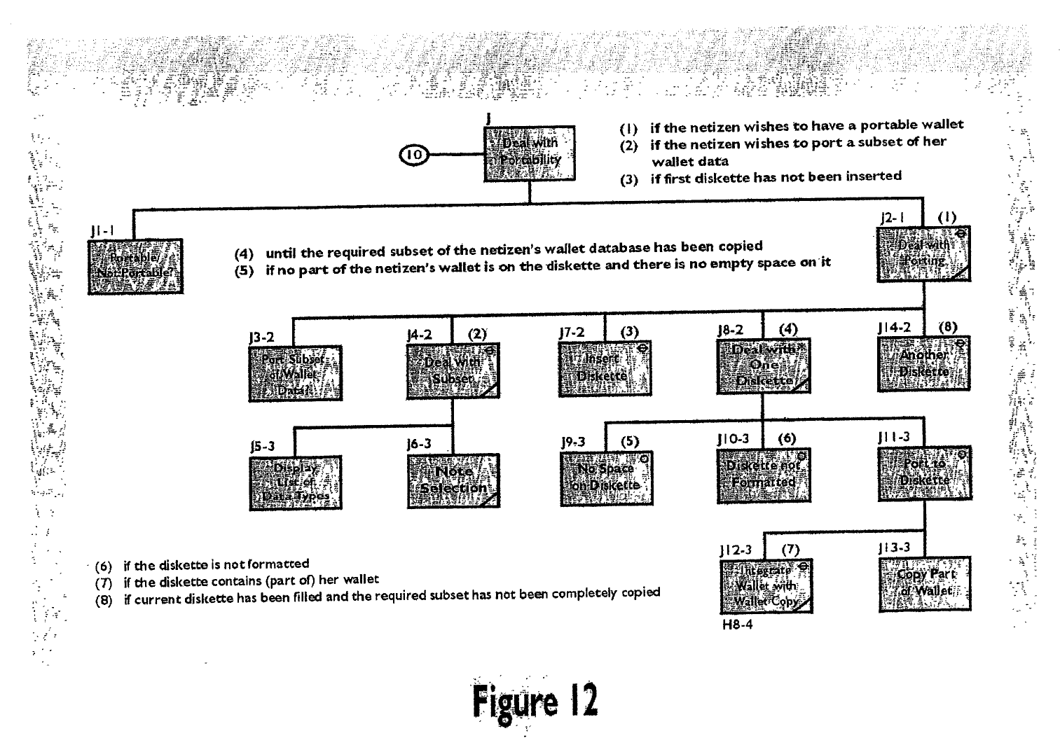

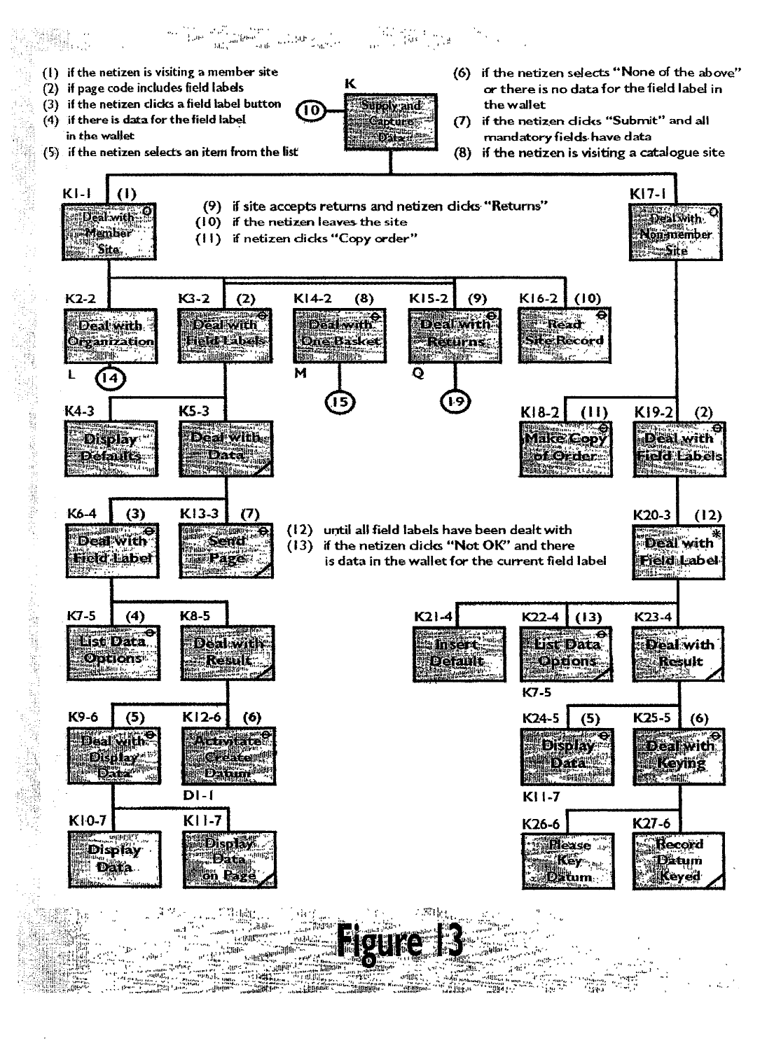

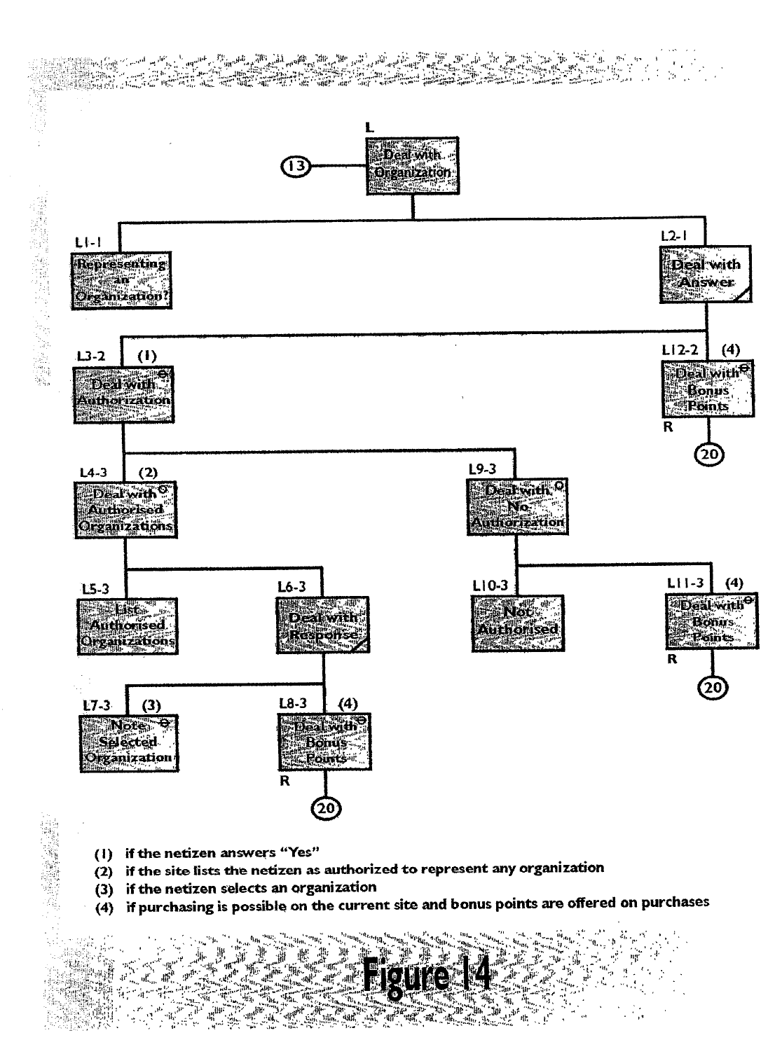

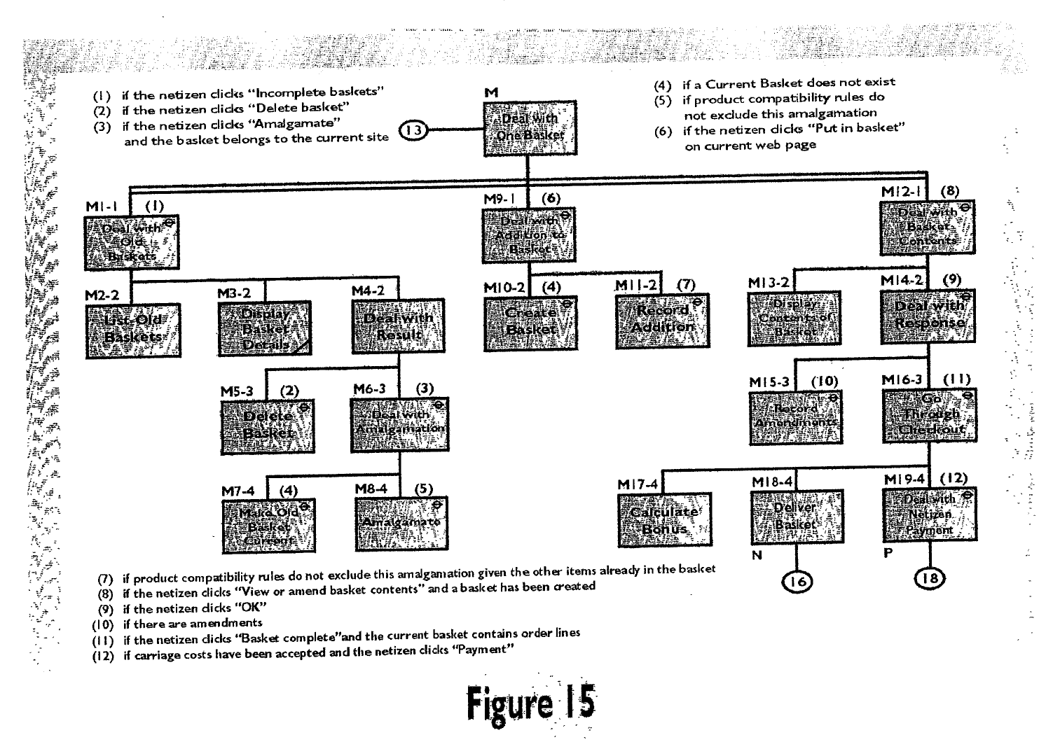

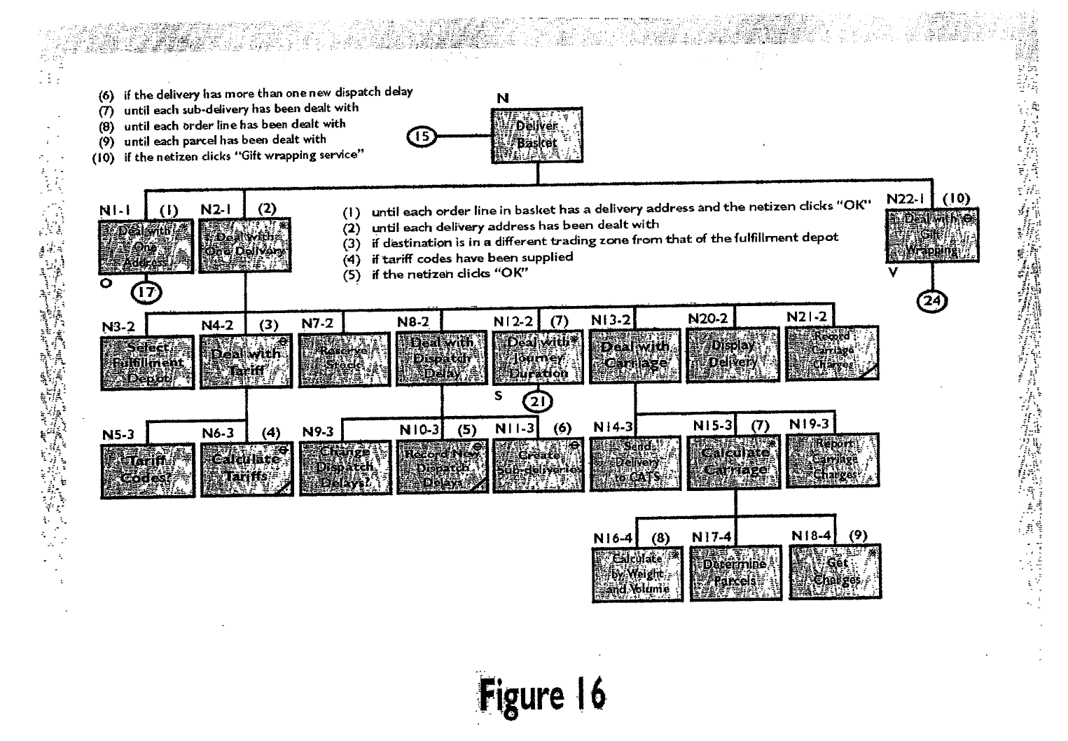

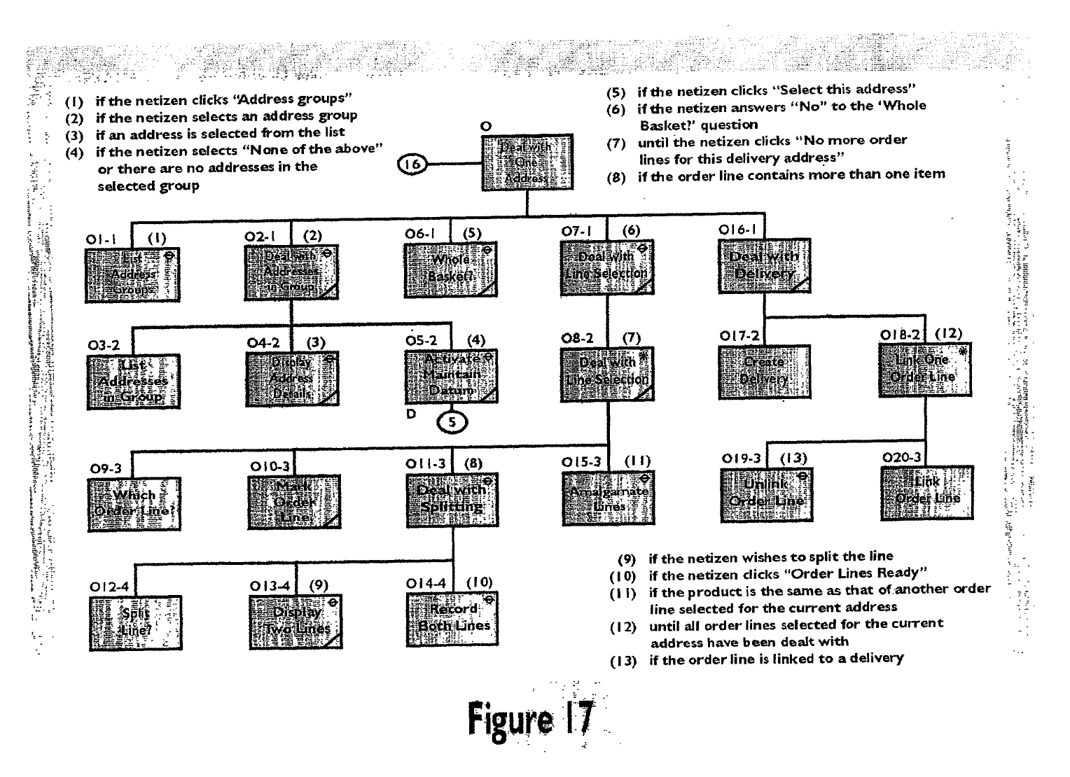

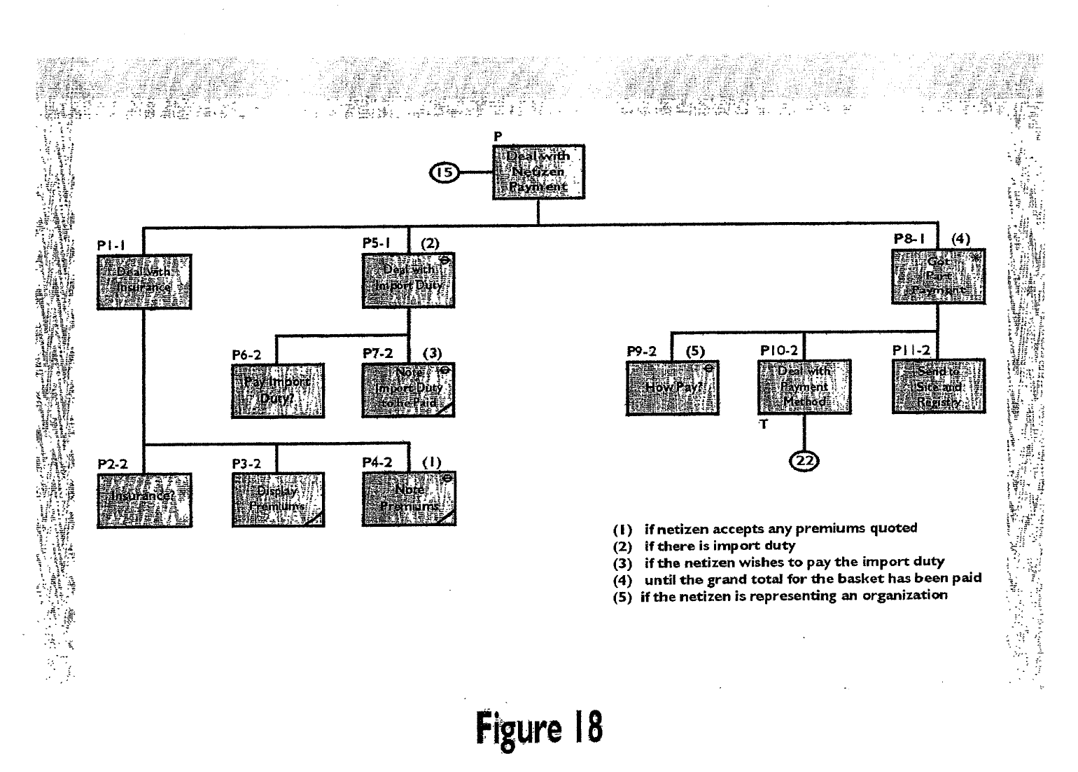

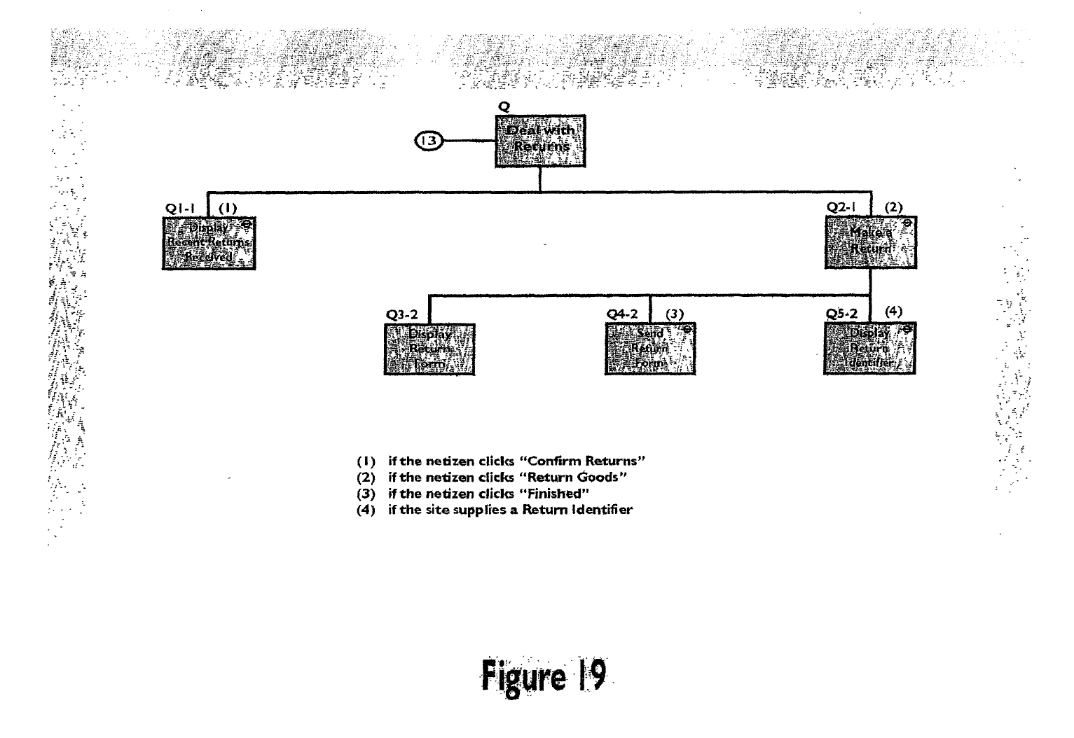

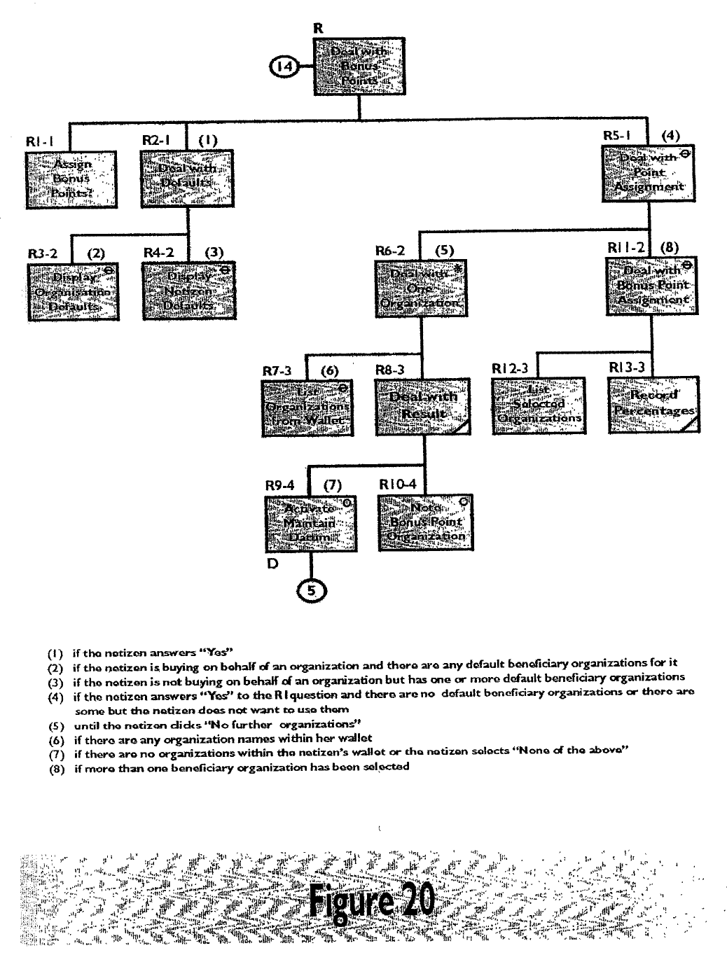

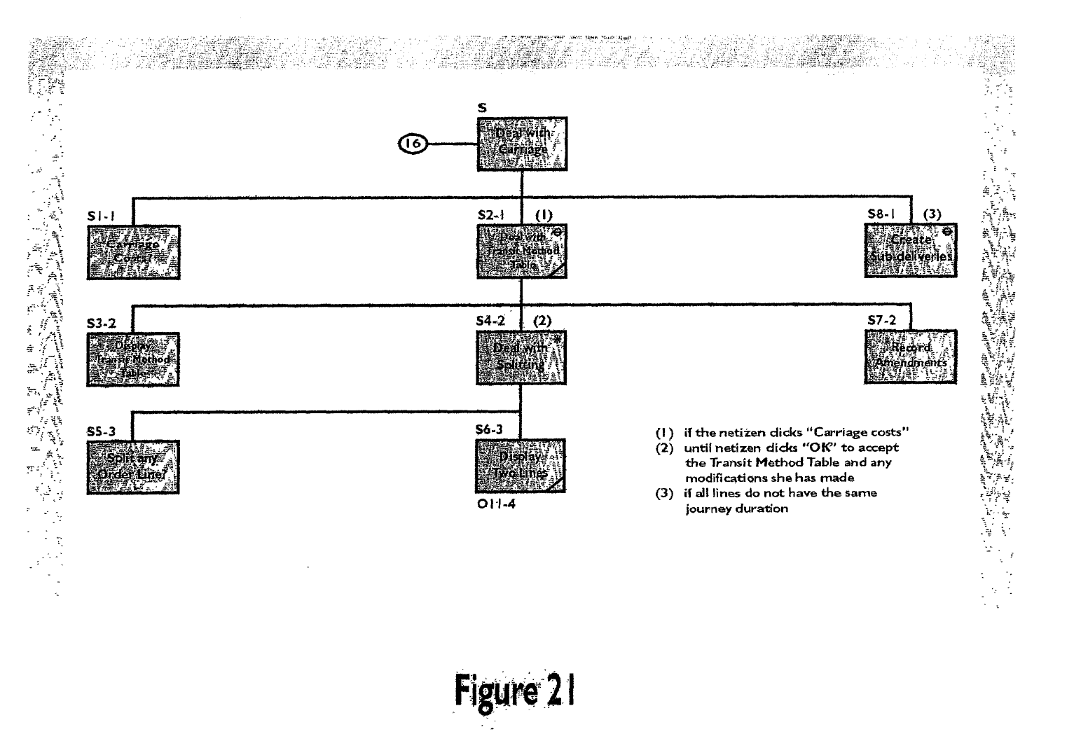

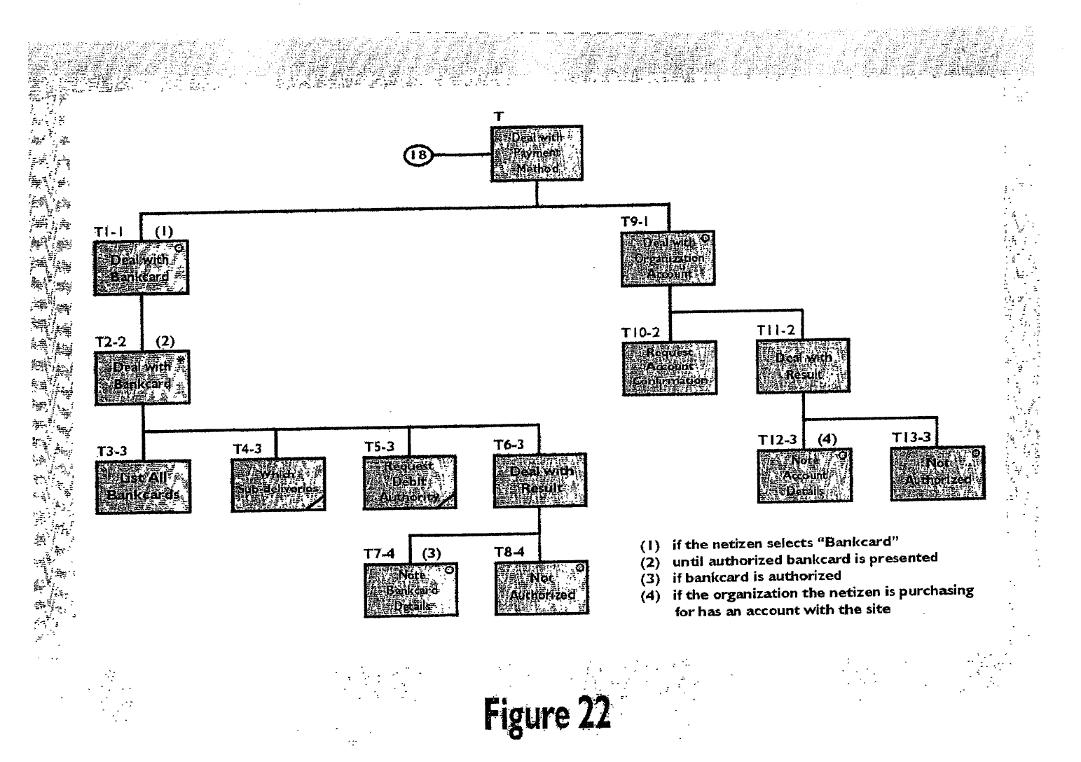

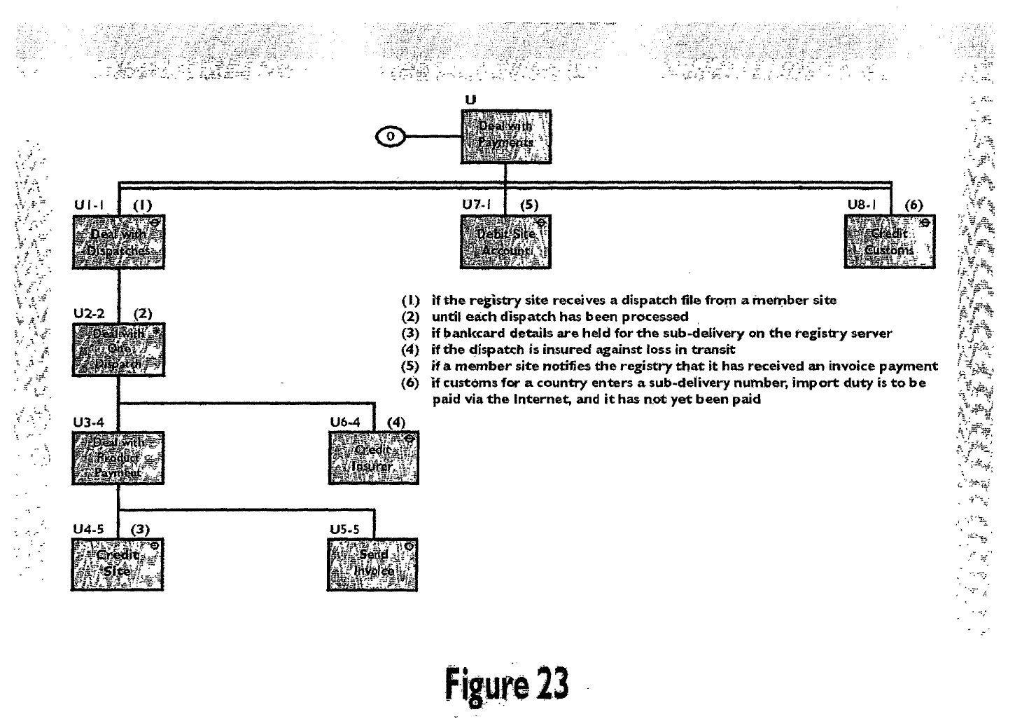

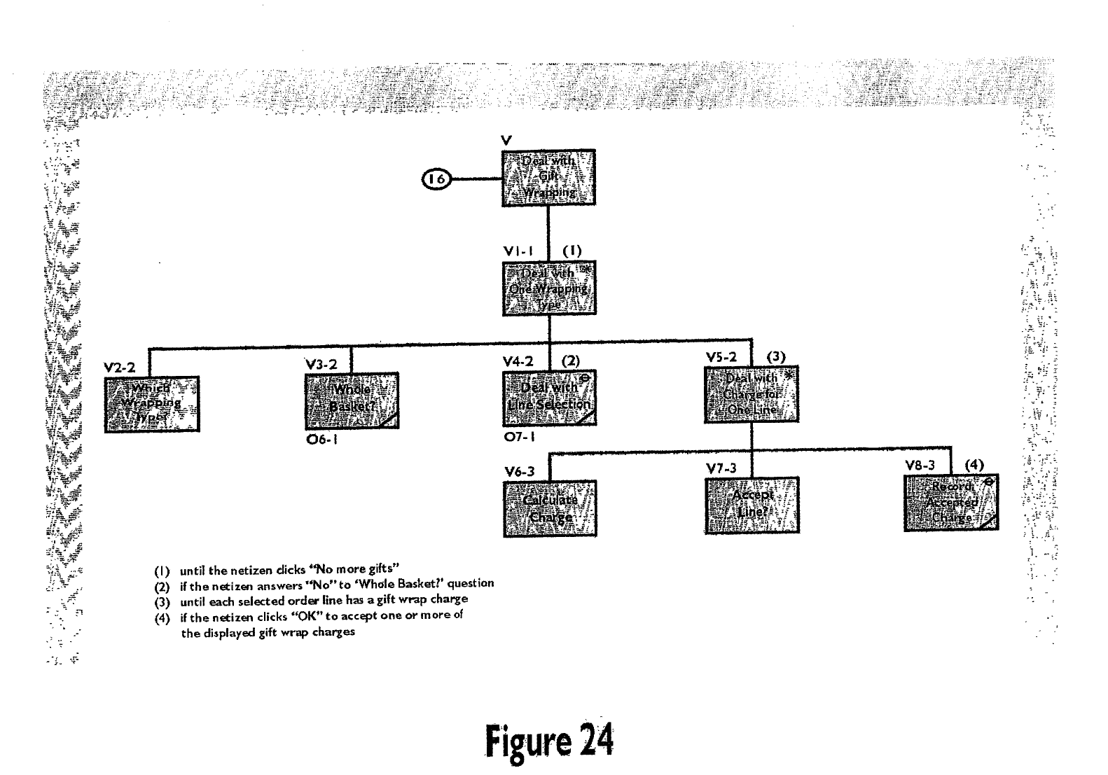

The detailed description of The Flexible, Orienting, and Better Shopping Wallet for Netizens method is in the form of a structured narrative. Its structure is shown in the FIGS. 1-20 which should be read as follows: perform the process named in a box in the sequence: left to right and depth-first; if a box has an asterisk in the top right-hand corner, perform the process named an indefinite number of times until a specified condition obtains; if a box has an “O” in the top right-hand corner, perform the process if a specified condition obtains or else perform the process named in the immediately succeeding box with a “O” in the top right-hand corner; if a box has an “O” with a line through it in the top right-hand corner, perform the process if a specified condition obtains or else do nothing. If there is a “/” in the bottom right-hand corner of a box, then it is not performed unless the netizen responds as permitted by the box preceding it by either filling in a form, answering a question, or selecting from a list. If the line connecting several boxes in a row is a double line, then the connected boxes can be performed in any order.

The circled numbers attached to the first box on each page refer to the figure to which the current figure is linked. Other circled numbers refer to figures that are linked to the current figure. The number after the dash on each box is the level number in the hierarchy of boxes.

In the narrative below, Section A covers all the boxes in the figures whose numbers are pre-fixed with A. Similarly for Sections B-H and J-V; there is no Section I.

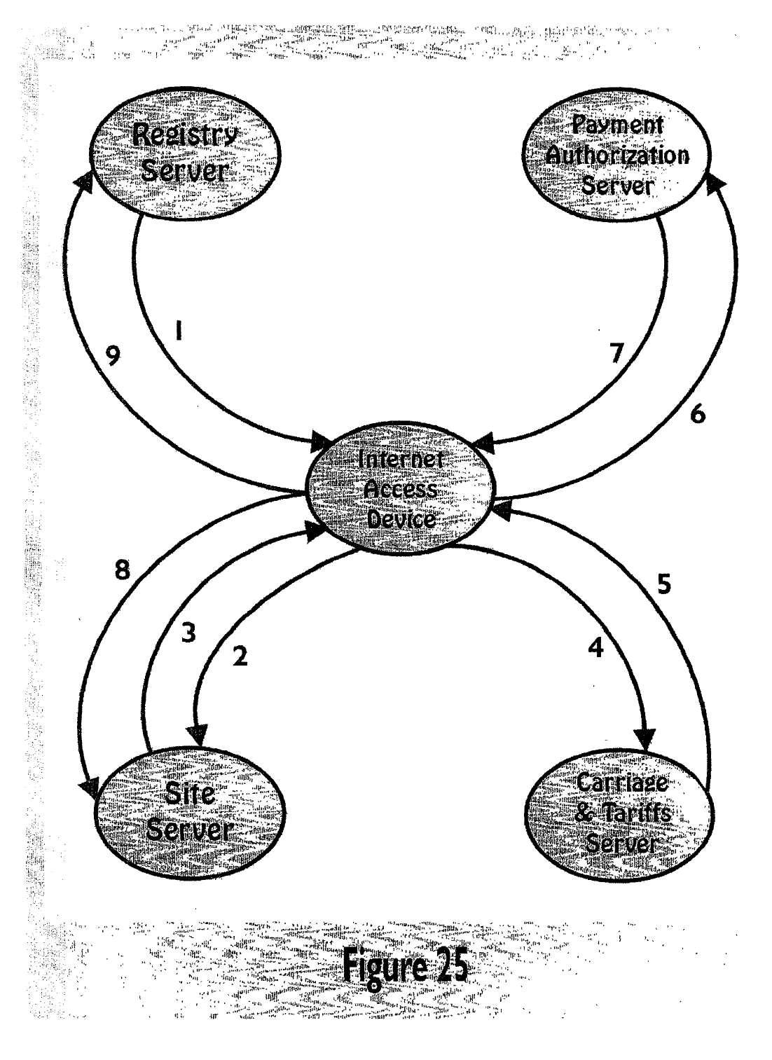

FIG. 25 shows the flow of data for The Flexible, Orienting, and Better Shopping Wallet for Netizens method:

1. Wallet management software is downloaded from the Registry Server to the current Internet Access Device (IAD) as soon as the netizen registers on the registry server. It includes a date when the next version of the software will become available. At a later date if the registered netizen wishes to work at an IAD to which this software has not been downloaded, she can instruct the registry server to download it to this new IAD. At registration time, if the newly registered netizen wishes her wallet database to start its life in “Clientside” mode then it will also be down loaded from the registry server to the IAD. At the beginning and end of every session in which she uses her wallet while accessing the web, she can choose to download her wallet database from the registry server to her current IAD, if it is on the registry server. Whenever a new version of the wallet management software becomes available it is downloaded from the Registry Server to the IAD together with a date when the next version will be available.

2. When the netizen opens her wallet within a web session, the wallet management software extracts the netizen's preferred languages and wallet language and other data from the netizen's wallet (wherever it is located), and supplies them to the Site Server. The wallet management software on the IAD also supplies data for any fields on site pages which are then sent to the site server. The IAD also asks the site server to authorize a netizen who claims to be representing an organization. If the netizen does some catalog shopping, then the netizen's browser on the IAD allows her to ask the site to request site pages. Also the wallet management software on the IAD will send messages to the site server that will reserve goods for the netizen in the site's fulfillment depot, and ask the site server to report on whether an organization has an account with the site.

3. The site server supplies pages including thumbnails of products in a selected category or full details for a product (including description, standard and special prices, permitted transit methods, sales tax rate, bonus point rate, and compatibility rules) to the IAD as requested by the netizen. The site server sends answers to questions posed by the wallet management software on the IAD: a list of organizations the netizen is authorized to represent; the dispatch delay for goods in the netizen's basket, confirmation or otherwise that an organization has an account with the site, acceptance of the netizen's order.

4. If the netizen does catalog shopping on a site the wallet management software on the IAD sends the details of a proposed delivery including the transit methods to be used to transport it to the Carriage and Tariffs Server (CATS).

5. For this delivery the CATS supplies to the IAD wallet management software the figures for any sales tax due, any import duty payable, the journey durations for each permitted transit method, and the carriage charge for each selected transit method.

6. The IAD wallet management software sends the amount that a netizen wishes to debit to one of her bankcards together with the card identifier to The Payment Authorization Server (PAS)

7. The PAS sends an authorization or rejection to the IAD wallet management software

8. If the netizen does catalog shopping on a site the wallet management software on the IAD sends the whole basket along with payment details to the Site Server.

9. When the netizen opens her wallet within a web session, the wallet management software on the IAD first determines whether the date on which a new version of the software becomes available has arrived. If it has arrived, it asks the Registry Server to download the new version. If the netizen does catalog shopping on a site the wallet management software on the IAD sends the whole basket when it has been through the checkout process along with payment details to the Registry Server.

Provide a Flexible, Orienting and Better Shopping Wallet

Let A be any wallet database. Let B be any wallet database other then A.

As used below:

“to synchronize wallets A and B” means “to add any extra data that is found in the wallet A database that is not in the wallet B database to the wallet B database and vice versa and, if there are any conflicts between the two, to either record both versions or ask the netizen to say which of each pair of conflicting values is correct, and to overwrite the incorrect with the correct one in both databases”.

“to integrate (part of) wallet A with wallet B” means “to add any extra data that is found in the wallet A database that is not in the wallet B database to the wallet B database and, if there are any conflicts between the two, to either record both versions or ask the netizen to say which of each pair of conflicting values is correct, and if the incorrect one is in the wallet B database to overwrite it with the correct one”.

“unique identifier” means “a user name followed by a password where the password is unique with the user name within the registry”.

“web session” means “a period during which the Internet is accessed using a browser on a given IAD”.

“wallet session” means “a period initiated by the opening of a netizen's wallet during a web session”.

In what follows it is understood that if there is inadequate physical space to complete the task when copying a wallet database from one medium to another, integrating one wallet database with another, or synchronizing two wallet databases, then the netizen is told that this is so and the process stops.

(A) is performed on the registry site server during a web session using the current Internet Access Device (IAD). (F) is performed on the netizen's current IAD. (G) is performed during a web session on the netizen's current IAD.

Perform

A Deal with Registry, if the netizen visits the registry

F Deal with Desk Top Usage, if the netizen clicks the wallet desk top icon

G Deal with Web Session Usage, if the netizen clicks the wallet browser icon

U Deal with Payments, if a dispatch file, or a customs import duty demand is received by the registry

Section A: Deal with Registry

Communicate with the netizen, use the natural language selected in §1 until the end of §8. From §9 onwards use the natural language selected in §8 for all other parts of Section A (Sections A-E).

Perform

1 Deal with Registration Question

4 Deal with Answer

1. Deal with Registration Question

Perform

2 List the Wallet Languages

3 Registered?

List the Wallet Languages

Provide a list of the names of natural languages used for wallets—use the name of the language used by the speakers of the language. The netizen can select one.

3. Registered?

The registry site asks the netizen whether she has already registered. She can only reply “Yes” or “No”. Ask the question and present the possible answers in the natural language selected by the netizen from the list in §1.

4. Deal with Answer

Perform

5 Deal with Applicant, if netizen replies “No”

Else

26 Deal with Member

5. Deal with Applicant

Perform

6 Deal with Language and Currency

10 Deal with Unique Identifier

15 Deal with Password Verification

18 Deal with Registration Data

25 Deal with Server-side versus Client-side

6. Deal with Language and Currency

Perform

7 List Languages

8 List Wallet Languages

9 List Hard and Soft Currencies

7. List Languages

Present a list of natural languages. Ask the netizen to select at most three languages and rank them according to his usage preferences. Note these language preferences.

8. List Wallet Languages

List all the languages in which the wallet is available and ask the netizen to select the one that she wishes her wallet to use. Note the wallet language preference.

9. List Hard and Soft Currencies

List the hard currencies and list the soft currencies. Ask the netizen to select from either list the currency she wishes to use for purchases made within her own country or trading zone. Also ask the netizen to select from the list of hard currencies the one that she wishes to use for purchases outside her country or trading zone.

10. Deal with Unique Identifier

Perform

11 Present Unique Identifier Form

12 Deal with Unique Identifier, until a unique identifier has been recorded

11. Present Unique Identifier Form

Present form with fields into which the netizen can key her user name and password.

12. Deal with Unique Identifier

Perform

13 Enter a Different Password, if password is not unique within user name

Else

14 Record Unique Identifier

13. Enter a Different Password Refresh the password field and invite the netizen to enter a new password.

14. Record Unique Identifier Create a record of the new netizen using this unique identifier.

15. Deal with Password Verification

Perform

16 Present Second Password Field

17 Deal with Unique Identifier, if second entry of password does not match the first

16. Present Second Password Field

Add a second password field to the unique identifier form. Ask netizen to enter her password a second time to verify it.

17. Deal with Unique Identifier

Perform §4 of Section A after deleting the record created in §14 of Section A.

18. Deal with Registration Data

Perform

19 Validate Registration Data

22 Deal with Recording Registration

19. Validate Registration Data

Perform

20 Present Registration Form

21 Validate One Datum, until all data are valid

20. Present Registration Form

Display a registration form that allows the netizen to enter her full name and address, a question and the answer to it where the question is such that she alone knows the answer, her email address, her date and place of birth, her trading zone (if any), and optionally her electronic signature. The netizen can fill in the form.

21. Validate One Datum

Perform §3 in Section D.

22. Deal with Recording Registration Data

Perform

23 Deal with Member, if the surname plus date and place of birth are already on the register

Else

24 Record Registration Data

23. Deal with Member

Perform Section E and delete the record created in §8 of Section A.

24. Record Registration Data

Tell her that she is now registered and update the record already created in §8 of section A with this registration data.

25. Deal with Server-side versus Client-side

Perform Section B

26. Deal with Member

Perform Section E.

Section B: Deal with Server-side Versus Client-side

Perform

1 Check the Internet Access Device

2 Deal with Result

9 Deal with Referral

1. Check the Internet Access Device

Determine whether the netizen's current IAD has enough space on its permanent storage medium to store and operate a client-side wallet.

2. Deal with the Result

Perform

3 Deal with Server-side/Client-side, if the Internet access device is up to the job of holding and managing a client-side wallet

8 Create a Server-side Wallet

3. Deal with Server-side/Client-side

Perform

4 Server-side/Client-side?

5 Deal with Result

4. Client-side/Server-side?

Explain the advantages and disadvantages of client-side wallets versus server-side wallets. Tell her that her wallet is flexible which means that for any particular wallet session she can select whichever mode she wishes to use. Ask her where she would like her wallet to be placed for now: client-side or server-side.

5. Deal with Result

Perform

6 Create a Netizen Selected Server-side Wallet, if the netizen elects to use a server-side wallet during her first wallet session

Else

7 Create a Client-side Wallet

6. Create a Netizen-selected Server-side Wallet

Download the multilingual desk top software and the multilingual browser software onto the current IAD. Include in the browser software a date on which the registry is to be accessed in order to download version updates of all client-side software. Create a server-side wallet for the netizen that includes her unique identifier, her registration data, and the wallet language and the currencies selected in §6 of Section A.

7. Create a Client-side Wallet

Download the multilingual desk top software and the multilingual browser software onto the current IAD. Include in the browser software a date on which the registry is to be accessed in order to download version updates of all client-side software. Download the netizen's wallet containing her unique identifier, her registration data, and the wallet language selected in §6 of Section A.

8. Create a Server-side Wallet

Download the multilingual browser software onto the current IAD. Include in the browser software a date on which the registry is to be accessed in order to download version updates of all client-side software. Create a server-side wallet for the netizen that includes her unique identifier, her registration data, and the wallet language selected in §6 of Section A. Also within this browser software set Thin Client Indicator to “Yes” to indicate that the IAD cannot support a client-side wallet.

9. Deal with Referral

Perform

10 Deal with Facilities, if a server-side wallet has been created and the netizen has not been referred from another site

11 Return to Referring Site, if the netizen has been referred from another site

10. Deal with Facilities

Perform Section C.

11. Return to Referring Site

Return the netizen's Internet Access Device (IAD) to the page from which she was referred to the registry site.

Section C: Deal with Facilities

Perform

1 Present Facilities Menu

2 Deal with Response

1. Present Facilities Menu

Present a list of facilities consisting of: Update Wallet, Set up Browser, Archive, View Archive, and Reports. If this Section is being performed within Section F: Deal with Desk Top Usage, do not include “Set up Browser”

2. Deal with Response

3 Synchronize Server and Client Wallets, if the netizen has a wallet on the current IAD as well as on the server

4 Have Diskette Wallet?

5 Deal with Diskettes, if netizen has a diskette wallet

6 Deal with Wallet Update, if the netizen selects “Update Wallet”

12 Set up Browser, if netizen selects “Set up Browser”

17 Archive, if netizen selects “Archive”

18 View Archive, if netizen selects “View Archive”

19 Deal with Reports, if netizen selects “Reports”

3. Synchronize Server and Client Wallets

Perform §1 of Section H.

4. Have Diskette Wallet?

Perform §2 of Section H.

5. Deal with Diskettes

Perform §3 of Section H.

6. Deal with Wallet Update

Perform

7 Deal with Wallet Update

11 Synchronize Client- and Server-side Wallets, if the netizen has a wallet on the current IAD as well as on the server

7. Deal with Wallet Update

Perform

8 List Data Types

9 Create or Amend?

10 Deal with Response

8. List Data Types

List all the types of data held in the wallets. The netizen can select one from this list.

9. Create or Amend?

Ask the netizen whether she wants to create new data or amend existing data.

10. Deal with Response

Perform Section D

11. Synchronize Server and Client Wallets

Perform §1 of Section H.

12. Set up Browser

Perform

13 Check the Internet Access Device

14 Deal with Result

13. Check the Internet Access Device

Perform §1 of Section B.

14. Deal with Result

Perform

15 Download Browser and Local Software, if the Internet access device is up to the job of holding and managing a client0side server wallet.

Else

14 Download Browser Software

15. Download Browser and Local Software

Download the software required on the IAD for managing the use of a wallet during a web session. Download the software that enables a netizen to update and manage her wallet on her IAD.

16. Download Browser Software

Download the software required on the IAD for managing the use of a wallet during a web session.

Archive

Allow the netizen to specify the location of her archive files. Allow netizen to supply a date. Copy the audit trail occurring before this date, the orders, donations, and medical records ‘last updated’ prior to this date, addresses ‘last used ’ prior to this date to the location specified and delete them from the wallet.

18. View Archive

Allow the netizen to specify the location of her archive files. Display the various sections of the archive on request and allow the netizen to select portions of it for restoration to the wallet.

19. Deal with Reports

Perform

20 Report on Audit Trail, if netizen selects “Audit Trail”

21 Deal with Specified Data Type, if netizen selects “Data”

25 Report on Orders Placed on Member Sites, if netizen selects “Member Site Orders”

26 Report on Orders Placed on Non-member Sites, if netizen selects “Nonmember Site Orders”

20. Report on Audit Trail

List all wallet database amendments in time and date order. This includes records of data given by the netizen to a site from her wallet as well as records of data given by a site to the netizen's wallet.

21. Deal with Specified Data Type

Perform

22 List Data Types

23 List Data Sets for Data Type

24 Display Data for Data Set

22. List Data Types

Perform §8 in Section C.

23. List Data Sets for Data Type

Perform §9 in Section D.

24. Display Data for Data Set

Perform §13 in Section D.

25. Report on Orders Placed on Member Sites

Display the order details in creation date order within supplier.

26. Report on Orders Placed on Non-member Sites

Display orders in creation date order.

### Section D: Deal with Response

Perform

1 Deal with Create, if netizen selects “Create”

Else

8 Deal with Amend Data

1. Deal with Create

Perform

2 Present Form for Data Type

3 Validate One Datum, until all data is valid

7 Record Data in Wallet

2. Present Form for Data Type

Display the form that fits the data type selected by the netizen from the list of data types.

3. Validate One Datum

Perform

4 Validate One Datum, until the datum is valid

4. Validate One Datum

Perform

5 Validate Datum

6 Display Error Messages, if invalid datum entered

5. Validate Datum

Apply the relevant validation rules to the datum.

6. Display Error Messages

Display error message corresponding to validation rule broken.

7. Record Data in Wallet

Record the new data in the netizen's wallet database.

8. Deal with Amend Data

Perform

9 List Data Sets for Data Type

10 Alter/Delete?

11 Deal with Answer

9. List Data sets for Data Type

List the names or meaningful identifiers of the sets of data for the data type already selected. The netizen can select one set of data

10. Alter/Delete?

Invite the netizen to indicate whether she wishes to alter the data within the selected set or to delete the whole set.

11. Deal with Answer

Perform

12 Deal with Delete, if the netizen selects “Delete”

Else

15 Deal with Alter

12. Deal with Delete

Perform

13 Display Data for Data Set

14 Delete Data Set, if netizen confirms deletion

13. Display Data for Data Set

Display the data composing the data set selected from the list of data set names. Ask netizen to confirm that she wishes to delete this set.

14. Delete Data Set

Delete the data set from the wallet database.

15. Deal with Alter

Perform

16 Display Data for Data Set

17 Validate One Datum, until all data are valid

18 Record Alterations

16. Display Data for Data Set

Perform §12 from Section D.

17. Validate One Datum

Perform §3 from Section D.

18. Record Alterations

Record the altered data on the netizen's wallet database.

Section E: Deal with Member

1 Present Unique Identifier Form

2 Deal with Identifier Input

1. Present Unique Identifier Form

Perform §4 of Section A.

2. Deal with Identifier Input

Perform

3 Deal with Unknown Identifier, if unknown identifier is entered

15 Deal with Facilities, if known identifier is entered, the netizen's wallet is server-side, and netizen is not engaged in a web session.

3. Deal with Unknown Identifier

Perform

4 Try Again?

5 Deal with Reply

4. Try Again?

Tell the netizen that the identifier entered is not known to the register and invite her to try again.

5. Deal with Reply

Perform

6 Deal with Member, if netizen wishes to try again

7 Deal with Identifier Revision

6. Deal with Member

Perform Section E

7. Deal with Identifier Revision

Perform

8 Deal with Stage One

11 Deal with Stage Two, if full name, date and place of birth found

14 Present User Name, if special question answered correctly

8. Deal with Stage One

Perform

9 Ask for Name, Place & Date of Birth

10 Deal with Applicant, if full name, date and place of birth not found

9. Ask for Name, Place & Date of Birth

Ask for the netizen for her surname and also for her date and place of birth.

10. Deal with Applicant

Perform §3 in Section A.

11. Deal with Stage Two

Perform

12 Ask Special Question

13 Deal with Applicant, if special question not answered correctly

12. Ask Special Question

Display the special question recorded by the netizen on the register.

13. Deal with Applicant

Perform §3 in Section A.

14. Present User Name

Display the user name belonging to this netizen and invite her to enter a new password.

15. Deal with Facilities

Perform Section C

Section F: Deal with Desk Top Usage

In this Section to communicate with the netizen, use the language selected in §1 until the end of §7: from §8 use the preferred language noted in her wallet.

Perform

1 Deal with Registration Question

2 Deal with Registration Answer

1. Registered?

Perform §1 in Section A.

2. Deal with Registration Answer

Perform

3 Deal with Applicant, if netizen says “I have not registered yet”.

4 Deal with Member Locally, if there is at least one wallet database on the IAD

Else

9 Deal with Member

3. Deal with Applicant

Automatically access the registry site and perform §3 of Section A.

4. Deal with Member Locally

Perform

5 Present Unique Identifier Form

6 Deal with Input

5. Present Unique Identifier Form

Perform §5 in Section A on the IAD.

6. Deal with Input

Perform

7 Deal with Identifier Input, if the netizen's wallet is not on the IAD

Else

8 Deal with Facilities

7. Deal with Identifier Input

Automatically access the registry site and perform §2 of Section E.

8. Deal with Facilities

Perform Section C on the IAD.

9. Deal with Member

Automatically access the registry site and perform Section E.

Section G: Deal with Web Session Usage

In this Section to communicate with the netizen use the language selected in §1 until the end of §2. From §12 use the preferred language noted in her wallet.

Perform

1 Deal with Registration Question

2 Deal with Registration Answer

12 Deal with Mode

13 Deal with One Site, until the netizen selects “Close Wallet”

16 Deal with Wallet Session End

1. Deal with Registration Question

Perform §1 in Section A.

2. Deal with Registration Answer

Perform

3 Deal with Applicant, if netizen says “I have not registered yet”.

4 Deal with Member Locally, if there is at least one wallet database on the IAD

Else

9 Deal with Member at Registry

3. Deal with Applicant

Automatically access the registry site and perform §3 of Section A.

4. Deal with Member Locally

Perform

5 Present Unique Identifier Form

6 Consult Register, if the netizen's wallet is not on the IAD

5. Present Identifier Form

Perform §5 in Section A on the IAD.

6. Consult Register

Perform

7 Access Registry Server

8 Deal with Identifier Input

7. Access Registry Server

Access the registry site server.

8. Deal with Identifier Input

Perform §2 of Section E.

9. Deal with Member at Registry

Perform

10 Access Registry Server

11 Deal with Member

10. Access Registry Server

Perform §7 of Section G.

11. Deal with Member

Perform Section E.

12. Deal with Mode

Perform Section H.

13. Deal with One Site

Perform

14 Supply Netizen Details, when the netizen sends a URL in order to access a site or when she opens her wallet within a web session by clicking on the wallet browser icon

15 Supply and Capture Data

14. Supply Netizen Details

Send nick name, gender, preferred languages, wallet language, home (country or trading zone) currency and import currency for the current wallet to the site being accessed.

15. Supply and Capture Data

Perform Section K.

16. Deal with Wallet Session End

Perform

17 Deal with Wallet Location, if Thin Client =No

21 Deal with Portability, if wallet is to be stored client-side

22 Close Wallet

17. Deal with Wallet Location

Perform

18 Client/Server?

19 Move Wallet from Server to Client, if the netizen selects “Client-side” and her wallet is server-side

20 Move Wallet from Client to Server, if the netizen selects “Server-side” and her wallet is client-side

18. Client/Server

Perform §4 of Section B.

19. Move Wallet from Server to Client

Perform §21 of Section H

20. Move Wallet from Server to Client

Perform §22 of Section H.

21. Deal with Portability

Perform Section J.

22. Close the Wallet

Close the netizen's wallet.

Section H: Deal with Mode

Perform

1 Have Diskette Wallet?

2 Deal with Diskettes, if netizen has a diskette wallet

12 Synchronize Server and Client Wallets, if the netizen's wallet is on both the client and the server

13 Create Temporary Wallet, if the netizen's wallet is on neither the client nor the server

14 Deal with Client/Server, if Thin Client=“No”

23 Display Wallet Open Button

1. Have Diskette Wallet?

Ask netizen whether she has a diskette wallet.

2. Deal with Diskettes

Perform

3 Deal with One Diskette, until netizen says “No” in response to “Another Diskette?”

3. Deal with One Diskette

Perform

4 Insert Diskette, if no diskette containing her wallet has been inserted

5 Another Diskette? if first diskette has been dealt with

6 Deal with Wallets, if netizen inserts a diskette containing (part of) her wallet into IAD diskette reader

11 Wallet not on Diskette, if no part of the netizen's wallet is on the diskette

4. Insert Diskette

Invite the netizen to insert a diskette containing her wallet into the diskette reader of her IAD and to click “OK” when it has been inserted.

5. Another Diskette

Ask the netizen whether her diskette wallet has a further diskette and invite her to click “OK” when this further diskette has been inserted.

6. Deal with Wallets

Perform

7 Integrate Wallet with IAD Wallet-copy, if the netizen's wallet-copy is on the IAD

8 Integrate Wallet with Server Wallet-copy, if the netizen's wallet-copy is on the server but not on the IAD

9 Copy Wallet to IAD, if the IAD is not a Thin Client and the netizen's wallet is on neither the IAD nor the server

Else

10 Copy Wallet to Server

7. Integrate Wallet with Wallet-copy

Integrate the wallet (part) on the diskette with the wallet-copy on the IAD.

8. Integrate Wallet with Wallet-copy

Integrate the wallet (part) on the diskette with the wallet-copy on the server.

9. Copy Wallet to IAD

Copy the wallet (part) on the diskette to the IAD.

10. Copy Wallet to Server

Copy the wallet (part) on the diskette to the server.

11. Wallet not on Diskette

Tell the netizen that no part of her wallet is on the disk currently in the diskette reader of the IAD.

12. Synchronize Server and Client Wallets

Synchronize the wallet on the server and the wallet on the IAD.

13. Create a Temporary Wallet

Create a server-side wallet for the netizen.

14. Deal with Client/Server

Perform

15 Client-side/Server-side?

16 Deal with Client/Server Answer

15. Client-side/Server-side?

Perform §4 of Section B.

16. Deal with Client/Server Answer

Perform

17 Deal with Two-wallet Situation, if the netizen's wallet exists both on the client and on the server

Else

20 Deal with Single Wallet

17. Deal with Two-wallet Situation

Perform

18 Delete Wallet from Server, if the netizen selects “Client-side”

Else

19 Delete Wallet from Client

18. Delete Wallet from Server

Delete the netizen's wallet from the server.

19. Delete Wallet from Client

Delete the netizen's wallet from the client.

20. Deal with Single Wallet

Perform

21 Move Wallet from Server to Client, if the netizen selects “Client” and her wallet is on the server

22 Move Wallet from Client to Server, if the netizen selects “Server” and her wallet is on the client

21. Move Wallet from Server to Client

Copy the netizen's wallet database from the server to the client and delete it from the server.

22. Move Wallet from Client to Server

Copy the netizen's wallet database from the client to the server and delete it from the client.

23. Display Wallet Open Button

Display a button labeled “Wallet Open” in the IAD browser to remind the netizen not to leave her IAD unattended while her wallet is open. By clicking on the button she can close her wallet.

Section J: Deal with Portability

1 Portable/Not Portable?

2 Deal with Porting, if the netizen wishes to have a portable wallet

1. Portable/Not Portable?

Ask the netizen whether she wishes her client-side wallet to be portable or not.

2. Deal with Porting

3 Port Subset of Wallet Data?

4 Deal with Subset, if the netizen wishes to port a subset of her wallet data

7 Insert Diskette, if first diskette has not been inserted

8 Deal with One Diskette, until the required subset of the netizen's wallet database has been copied

14 Another Diskette, if current diskette has been filled and the required subset has not been completely copied

3. Port Subset of Wallet Data?

Ask the netizen whether she wishes to port all the data in her wallet or only a subset of it.

4. Deal with Subset

Perform

5 Display List of Data Types

6 Note Selection

5. Display List of Data Types

Display a list of the types of data, e.g. address book, health record, insurance details, bankcard details, driver's license details, personal dimensions, baskets, orders.

6. Note Selection

Note the types of data that the netizen wishes to port.

7. Insert Diskette

Ask the netizen to insert the first diskette for her portable wallet.

8. Deal with One Diskette

Perform

9 No Space on Diskette, if no part of the netizen's wallet is on the diskette and there is no empty space on it

10 Diskette not Formatted, if the diskette is not formatted

11 Port to Diskette

9. No Space on Diskettes

Tell the netizen that there is no space on the currently inserted diskette, so the creation of her portable diskette wallet cannot proceed.

10. Diskette not Formatted

Tell the netizen that the diskette in the diskette reader has not been formatted, so the creation of her portable diskette wallet cannot proceed.

11. Port to Diskette

Perform

12 Integrate Wallet with Wallet Copy, if the diskette contains(part of) her wallet

13 Copy Part of Wallet

12. Integrate Wallet with Wallet Copy

Perform §8 of Section H.

13. Copy Part of Wallet

Copy to the current diskette any part of the wallet that has not already been copied during this wallet session and which is a part of the data subset that the netizen wants to port. Copy as much as will fit onto the diskette, overwriting any parts of the diskette's contents that are the netizen's wallet but not overwriting anything else.

14. Another Diskette

Ask the netizen to insert another diskette for her portable wallet and to click “OK” when she has inserted it.

Section K: Supply and Capture Data

Perform

1 Deal with Member Site, if the netizen is visiting a member site

17 Deal with Non-member Site

1. Deal with Member Site

Perform

2 Deal with Organization

3 Deal with Field Labels, if page code includes field labels

14 Deal with Baskets, if the netizen is visiting a catalogue site

15 Deal with Returns, if site accepts returns

15 Read Site Record, if the netizen leaves the site

2. Deal with Organization

Perform Section L

3. Deal with Field Labels

Perform

4 Display Defaults

5 Deal with Data

4. Display Defaults

Display a default value for each field label from the wallet. (Absence of a default value in the wallet is displayed as spaces).

5. Deal with Data

Perform

6 Deal with Field Label, if the netizen clicks a field label button

13 Send Page, if netizen clicks “Submit” and all mandatory fields have data

6. Deal with Field Label

Perform

7 List Data Options, if there is data for the field label in the wallet

8 Deal with Result

7. List Data Options

Display the list of data items or the names of the data sets found and include “None of the above” on the list. The netizen can select one of the items or “None of the above”.

8. Deal with Result

Perform

9 Deal with Display Data, if the netizen selects an item from list

12 Activate Create Datum, if the netizen selects “None of the above” or there is no data for the field label in the wallet

9. Deal with Display Data

Perform

10 Display Data

11 Display Data on Page

10. Display Data

Display the data for the option selected from the list and ask the netizen to indicate or confirm the required data set.

11. Display Data on Page

Display, within the site page at the place indicated by the field label, the datum or data set indicated or confirmed. Record that these data are being given to the current site on the current date and at the current time.

12. Activate Create Datum

Perform §1 of Section D within the wallet, where “Datum” is the data type required by the field label.

13. Send Page

Transmit the page to the current site server.

14. Deal with One Basket

Perform Section M.

15. Deal with Returns

Perform section Q.

16. Read Site Record

Retrieve from the site database any data held for the netizen that has not been supplied by the wallet.

17. Deal with Non-member Site

Perform

18 Make Copy of Order, if the netizen selects “Copy order”

19 Deal with Field Labels, if page code includes field labels

18. Make Copy of Order

Copy the data in the fields on the current site page into the netizen's wallet as unstructured text with line breaks as on the site page.

19. Deal with Field Labels

Perform

20 Deal with Field Label, if the netizen clicks “Not OK” and there is data in the wallet

20. Deal with Field Label

Perform

21 Insert Default

22 List Data Options, if there is data for the field label in the wallet

23 Deal with Result

21. Insert Default

Display the default value for the current field label in the appropriate field on the form.

22. List Data Options

Perform §7 of Section K.

23. Deal with Result

Perform

22 Display Data, if the netizen selects an item from the list

23 Deal with Keying, if the netizen selects “None of the above” or there is no data for the field label in the wallet

24. Display Data

Perform §10 of Section K

25. Deal with Keying

26 Please Key Datum

27 Record Datum Keyed

26. Please Key Datum

Ask the netizen to enter data into the field on the site page.

27. Record Datum Keyed

Record the data entered and the field label and link these two on the wallet base. Record that this datum is being given to the current site on the current and at the current time.

Section L: Deal with Organization

Perform

1 Representing an Organization?

2 Deal with Answer

1. Representing an Organization?

Ask the netizen whether she is authorized to represent an organization on the current site.

2. Deal with Answer

Perform

3 Deal with Authorization, if the netizen answers “Yes”

12 Deal with Bonus Points

3. Deal with Authorization

Perform

4 Deal with Authorized Organizations, if the site lists the netizen as authorized to represent any organization

9 Deal with No Authorization

4. Deal with Authorized Organizations

Perform

5 List Authorized Organizations

6 Deal with Response

5. List Authorized Organizations

List the organizations which the netizen is authorized to represent and display their names plus “None of the above”. Invite the netizen to select the one she is currently representing, if any.

6. Deal with Response

Perform

7 Note Selected Organization, if the netizen selects an organization

8 Deal with Bonus Points, if purchasing is possible on the current site and bonus points are offered on purchases

7. Note Selected Organization

Make a note of the details for the organization selected by the netizen from the list.

8. Deal with Bonus Points

Perform Section R.

9. Deal with No Authorization

Perform

10 Not Authorized

11 Deal with Bonus Points

10. Not Authorized

Tell the netizen that she is not authorized by the site to represent any organization in her dealings with the current site.

11. Deal with Bonus Points

Perform Section R.

12. Deal with Bonus Points

Perform Section R.

Section M: Deal with One Basket

Since the site being visited is a catalogue site, the netizen can select a category of product; thumbnail pictures are then displayed for the products in this category. She can select one of these thumbnails; information about the product shown in the thumbnail is then downloaded and displayed, e.g. large picture of the product, description, size, color, other products bundled with it, reviews, price, sale price, discounted price, special price, bundle price, bonus points per item. Any rules about its incompatibility with other products and any sales tax rate are also downloaded. The netizen can indicate that she wishes to put the product or bundle of products displayed into her current basket. This basket is held in her wallet database.

Perform

1 Deal with Old Baskets, if the netizen clicks “Incomplete baskets” in wallet

9 Deal with Addition to Basket, if the netizen clicks “Put in basket” on current web page

12 Deal with Basket Contents, if the netizen clicks “View basket contents” and a basket has been created

11. Deal with Old Baskets

Perform

2 List Old Baskets

3 Display Basket Details

4 Deal with Result

2. List Old Baskets

List all the Incomplete Baskets in date and time order. Invite the netizen to select one.

3. Display Basket Details

Display the order lines for the basket selected.

4. Deal with Result

Perform

5 Delete Basket, if the netizen clicks “Delete basket”

Else

6 Deal with Amalgamation, if the netizen clicks “Amalgamate” and the basket belongs to the current site

5. Delete Basket

Delete the selected basket from the netizen's wallet.

6. Deal with Amalgamation

Perform

7 Make Old Basket Current, if a Current Basket does not exist

8 Amalgamate, if the product compatibility rules do not exclude this amalgamation.

7. Make 10d Basket Current

Change the status of the selected Basket from Incomplete to Current. Display “View basket contents”.

8. Amalgamate

Copy the contents of the selected Incomplete Basket to the Current Basket and delete the Incomplete Basket.

9. Deal with Addition to Basket

Perform

10 Create Basket, if a Current Basket does not exist

11 Record Addition, if the product compatibility rules do not exclude this addition given the other items already in the basket.

10. Create Basket

Create a Current Basket in the netizen's wallet. Display “View basket contents”.

11. Record Addition

Record the product details of the selected product or bundle of products in the current basket within the wallet database: description, price, and quantity.

12. Deal with Basket Contents

Perform

13 Display Contents of Basket

14 Deal with Response, if the netizen clicks “OK”

13. Display Contents of Basket

Display all the order lines within the current basket. The netizen can amend the quantity in each line. She can click “OK” to indicate that she has finished.

14. Deal with Response

Perform

15 Record Amendments, if there are amendments

16 Go through Checkout, if the netizen clicks “Basket Complete” and the current basket contains order lines

15. Record Amendments

Record any quantity change for an order line belonging to the basket. Delete those order lines with a zero quantity. Redisplay the order lines in the basket.

16. Go through Checkout

Perform

17 Calculate Bonus

18 Deliver Basket

19 Deal with Netizen Payment, if carriage costs have been accepted and the netizen clicks “Payment”

17. Calculate Bonus

Calculate total bonus points for the basket. Divide the total bonus points among the beneficiary organizations for the current basket according to the recorded percentages. Display order lines each with a price and bonus points plus total price and bonus points. Display a table showing the bonus point allocation to beneficiary organizations.

18. Deliver Basket

Perform Section N.

19. Deal with Netizen Payment

Perform Section P.

Section N: Deliver Basket

Perform

1 Deal with One Address, until each order line in basket has a delivery address and the netizen clicks “OK”

2 Deal with One Delivery, until each delivery address has been dealt with

22 Deal with Gift Wrapping, if the netizen clicks “Gift wrapping service”

1. Deal with One Address

Perform Section O.

2. Deal with One Delivery

Perform

3 Select Fulfillment Depot

4 Deal with Tariff, if destination is in a different trading zone from that of the fulfillment depot

7 Reserve Stock

8 Deal with Dispatch Delay, if the delivery has more than one dispatch delay

12 Deal with Journey Duration, until each sub-delivery has been dealt with

13 Deal with Carriage

20 Display Delivery

21 Record Carriage Charges

3. Select Fulfillment Depot

The details for each fulfillment depot (the region in which it is located and the regions supplied from it—no region is supplied by more than one depot) owned by the current site are held on the Carriage and Tariffs Server (CATS). The netizen's wallet sends the delivery (delivery address and order lines) to CATS which then selects the fulfillment depot that supplies the region of the delivery address and calculate sales tax, if any. CATS sends the sales tax, if any, and the fulfillment depot identifier and region back to the IAD along with a statement about whether the destination of the delivery is in a different trading zone from the fulfillment depot plus rules under which no duty is due even though the two zones are involved. The sales tax, if any, is displayed on the IAD. Record sales tax, fulfillment depot and region, and the statement about trading zones.

4. Deal with Tariff

Perform

5 Tariff Codes?

6 Calculate Tariffs, if tariff codes have been supplied

5. Tariff Codes?

Invite the netizen to enter the import tariff code for each line. She is told the conditions for the current country under which no import duty is payable. Record import tariff code for each line, if any

6. Calculate Tariffs

Send the order lines along with tariff codes to CATS. This server determines the tariff rate and calculates the import duty for the one and sends these results back to the IAD. The IAD displays the delivery (all the order lines for the same address) showing import duty for those lines to which it applies.

7. Reserve Stock

Send the delivery to the Site Server. This server reserves the stock for one hour, (when the order is confirmed, it is fulfilled out of reserved stock). It also determines the dispatch delay for each order line. If the same dispatch delay cannot be given for all items in an order line, it splits the order line. It returns the delivery to the IAD with a dispatch delay attached to each order line plus for each order line the following details: weight, height, width, and length; gift wrap length per item, permitted transit methods, weight/volume packaging percentage, weight and/or volume indicator. The IAD records this data and displays the dispatch delays to the netizen.

8. Deal with Dispatch Delay

Perform

9 Change Dispatch Delays?

10 Record New Dispatch Delays, if the netizen clicks “OK”

11 Create Sub-deliveries, if the delivery has more than one dispatch delay

9. Change Dispatch Delays?

Tell the netizen that she can enter new dispatch delays that are higher, up to a specified limit, than the old ones supplied by the Site Server, if she wishes. Ask her to click “OK” when she has finished.

10. Record New Dispatch Delays

Where the netizen has not entered a new dispatch delay set it equal to the old dispatch delay reported by the Site Server for the current delivery. Record the old and the new dispatch delays—one pair for each order line.

11. Create Sub-deliveries

Group the order lines in the delivery into sub-deliveries, so that all members of a sub-delivery have the same dispatch delay. Record these new sub-deliveries and link them to the delivery. Delete the dummy sub-delivery.

12. Deal with Journey Duration

Perform Section S.

13. Calculate Carriage

Perform

14 Send Sub-delivery to CATS

15 Calculate Carriage, until each sub-delivery has been dealt with π19 Report Carriage Charges

14. Send Sub-delivery to CATS

Send the sub-deliveries for the current delivery to CATS along with dimensions, weight, packaging weight percentage, and packaging volume percentage for each product involved. Also send the selected transit method, fulfillment depot region and destination region for each sub-delivery.

15. Calculate Carriage

Perform

16 Calculate by Weight and Volume, until each order line has been dealt with

17 Determine Parcels

18 Get Charges, until each parcel has been dealt with

16. Calculate by Weight and Volume

Multiply the quantity ordered by the weight per item to give the order line weight. Multiply the packaging weight percentage by the order line weight to give the packaging weight. Add the packaging weight to the order line weight to give total order line weight. Get the carriage charge for the total order line weight traveling between the origin and destination supplied using the given transit method.

Multiply the quantity ordered by the shortest dimension to give ‘height’. Multiply the ‘height’ by the other two dimensions to give the order line volume. Multiply the packaging weight percentage by the order line volume to give the packaging volume. Add the packaging volume to the order line volume to give total order line volume. Get the carriage charge for the total order line volume traveling between the origin and destination supplied using the given transit method.

Multiply the packing price per item by quantity ordered to give order line packing charge.

Mark the order line with a “w” if the carriage charge by weight is higher than that the carriage charge by volume. Alternatively Mark the order line with a “v” if the carriage charge by volume is higher than that the carriage charge by weight.

17. Determine Parcels

Sum the total order line weights for all order lines marked “w” to give the total weight of the w-set. If the total is greater than the maximum allowed weight per parcel for the transit method, then assign items within the “w” set to parcels without exceeding this maximum. Calculate total weight for each parcel.

Sum the total order line volumes for all order lines marked “v” to give the total weight of the v-set. If the total is greater than the maximum allowed weight per parcel for the transit method, then assign items within the “v” set to parcels without exceeding this maximum. Calculate total volume for each parcel.

18. Get Charges

Select lowest carriage charge for each parcel—each parcel is a “w” or a “v” parcel. If it is a “w” parcel then the lowest charge by weight is selected. If it is a “v” parcel then the lowest charge by volume is selected. Determine carriage price for the transit method between the origin and destination regions. Sum the order line packing charges to give the total packing charge.

19. Report Carriage Charges

CATS sends the delivery back to the IAD with the sub-delivery lines sorted into parcels (where there is more than one parcel). It returns the charges for carriage and packing for each parcel.

20. Display Delivery

On the IAD display the delivery and its component parcels showing the order lines in each parcel. Display packing charge and carriage for each parcel. The netizen can click “Accept” to accept the carriage and packing charges. (She may prefer to repeat Section S).

21. Record Carriage Charges

Record the accepted carriage charges for the parcels composing the delivery.

22. Deal with Gift Wrapping

Perform Section V.

Section O: Deal with One Address

Perform

1 List Address Groups, if the netizen clicks “Address groups”

2 Deal with Addresses in Group, if the netizen selects an address group

6 Whole Basket?

7 Deal with Line Selection, if the netizen answers “No” to the ‘Whole Basket?’ question

16 Deal with Delivery

1. List Address Groups

The address groups (including “All” addresses) in the netizen's wallet are displayed as a list. Invite the netizen to select one category that may contain a delivery address for the current basket.

2. Deal with Addresses in Group

Perform

3 List Addresses in Group

4 Display Address Details, if an address is selected from the list

5 Activate Maintain Datum, if the netizen selects “None of the above” or there are no addresses in the selected group

3. List Addresses in Group

The addresses belonging to the selected group in the netizen's wallet are displayed along with “None of the above”. Invite the netizen to select one address as a delivery address for some or all of the items in the current basket.

4. Display Address Details

Display all lines of the address selected from the list together with the name of the organizations and or persons associated with that address. Invite the netizen to click “Select this address” after selecting one or more of the organizations and/or one or more of the persons associated with the address. Together these will constitute the destination to which some or all of the items in the basket will be delivered.

5. Activate Maintain Datum

Perform Section D.

6. Whole Basket?

Ask the netizen whether all the items in her basket are to go to the selected address.

7. Deal with Line Selection

Perform

8 Deal with Line Selection, until netizen clicks “No more order lines for this delivery address”

8. Deal with Line Selection

Perform

9 Which Order Line?

10 Mark Order Line

11 Deal with Splitting, if it contains more than one item

15 Amalgamate Lines, if the product is the same as that of other order lines selected for the current address

9. Which Order Line?

Ask the netizen to select an order line for the current address.

10. Mark the Order Line

Put the name of the current destination town and postal code next to the line to show that it has been selected for the current address.

11. Deal with Splitting

Perform

12 Split Line?

13 Display Two Lines, if the netizen wishes to split the line

14 Record Both Lines, if the netizen clicks “Order line ready”

12. Split Line?

Ask the netizen whether she wishes to split the selected line.

13. Display Two Lines

In place of the selected order line display two order lines. The netizen can alter the quantity in the first of these lines and the other line adjusts, so that the total is always equivalent to the quantity in the original pre-split line. When she has finished, she can click “Order lines ready”

14. Record Both Lines

Create new order line for the first of the split lines and display it with the town and postal code of the current address. Amend the existing order line to reflect the second line—if the quantity is zero delete it.

15. Amalgamate Lines

Amalgamate the current line with any other lines selected for the current address that concern the same product.

16. Deal with Delivery

Perform

17 Create Delivery

18 Link One Order Line, until all order lines selected for the current delivery address have been dealt with

17. Create Delivery

Create a new delivery and a new dummy sub-delivery. Link these two.

18. Link One Order Line

Perform

19 Unlink Order Line, if the order line is linked to a delivery

20 Link Order Line

19. Unlink Order Line

Delete any link between the order line and the dummy sub-delivery.

20. Link Order Line

Link the order line to the dummy sub-delivery just created.

Section P: Deal with Netizen Payment

Perform

1 Deal with Insurance

5 Deal with Import Duty, if there is import duty

8 Get Part Payment, until the grand total for the basket has been paid

1. Deal with Insurance

Perform

2 Insurance?

3 Display Premiums

4 Note Premiums, if the netizen accepts any premium quoted

2. Insurance?

Display all the deliveries composing the basket giving for each one the delivery address. For each sub-delivery give the dispatch delay and journey duration plus the totals for the goods, sales tax (if any), packing, carriage, and bonus points. For each order line show the unit and quantity prices, the bonus points, and the import duty (if any). Also provide the grand totals for the whole basket. Ask the netizen whether there are any sub-deliveries that she wishes to insure; she can answer by selecting either the whole basket or particular sub-deliveries.

3. Display Premiums

Send the sub-deliveries selected to CATS to get a premium for each of these. Receive the premiums quoted by CATS and display them on the IAD. Invite the netizen to mark the premiums she accepts.

4. Note Premiums

Note the accepted premiums and sum the premiums for the whole basket and for each sub-delivery. Add the insurance into the total price for each sub-delivery and for the whole basket.

5. Deal with Import Duty

Perform

6 Pay Import Duty?

7 Note Import Duty to be Paid, if the netizen wishes to pay the import duty

6. Pay Import Duty?

Ask the netizen to mark any sub-deliveries whose import duty she wishes customs to debit via the Internet when the goods arrive at customs in the importing country.

7. Note Import Duty to be Paid

Note for the selected sub-deliveries that their import duty is to be paid via the Internet.

8. Get Part Payment

Perform

9 How Pay? if the netizen represents an organization

10 Deal with Payment Method

14 Send to Site and Registry

9. How Pay?

Ask the netizen whether she wishes to pay by bankcard or via an account for the organization she is representing.

10. Deal with Payment Method

Perform Section T.

11. Send to Site and Registry

The IAD sends the basket details excluding any bankcard details to the site server for fulfillment.

Where import duty is to be paid via the Internet, ask the packers to put the sub-delivery number on the parcels composing it for the attention of customs in the destination country.

The IAD sends all basket details to the registration server except the individual order lines and any division of sub-deliveries into parcels.

Section Q: Deal with Returns

Perform

1 Display Recent Returns Received, if the netizen clicks “Confirm Returns”

2 Make a Return, if the netizen clicks “Return Goods”

1. Display Recent Returns Received

The site displays a list of returns received by the company owning the site from the netizen since a specified date. Note the return dates in the netizen's wallet.

2. Make a Return

Perform

3 Display Return Form

4 Send Return Form, if the netizen clicks “Finished”

5 Display Return Identifier, if the site supplies a Return Identifier

3. Display Return Form

Display the return form from the netizen's wallet. She can enter descriptions of the goods being returned.

Send Return Form

Send form to the site server by clicking “Submit”.

5. Display Return Identifier

The site replies with a return number. Store it in her wallet. She can print out a return slip that includes the number and the description of the goods. This slip should be included in the return parcel to identify it.

Section R: Deal with Bonus Points

Perform

1 Assign Bonus Points?

2 Deal with Defaults, if the netizen answers “Yes”

Deal with Bonus Point Assignment, if the netizen answers “Yes” to the §1 question and either there are no default beneficiary organizations or there are some but the netizen does not want to use them

1. Assign Bonus Points?

Ask the netizen whether any bonus points earned on purchases made during the current visit are to be donated to any organization(s) including the one she is representing, (if she is representing any).

2. Deal with Defaults

Perform

3 Display Organization Defaults, if the netizen is buying on behalf of an organization and there are any default beneficiary organizations for it

4 Display Netizen Defaults, if the netizen is not buying on behalf of an organization but has one or more default beneficiary organizations

3. Display Organization Defaults

Display the list of organizations held as default beneficiaries for the purchasing organization (which may include the purchasing organization itself), together with the percentage assigned to each organization. Invite the netizen to accept or reject the defaults as a whole.

4. Display Netizen Defaults

Display the list of organizations held as default beneficiaries for the netizen, together with the percentage assigned to each organization. Invite the netizen to accept or reject the defaults as a whole.

5. Deal with Bonus Point Assignment

Perform

6 Deal with One Organization, until the netizen clicks “No further organizations”

11 Deal, with Bonus Point Assignment, if more than one beneficiary organization has been selected

6. Deal with One Organization

Perform

7 List Organizations from Wallet, if there are any organization names within her wallet

8 Deal with Result

7. List Organizations from Wallet

Display a list of all the organization names recorded in the wallet plus “None of the above”. Invite the netizen to select an organization that is to receive some or all of the bonus points for the orders she is about to place.

8. Deal with Result

9 Activate Create Datum, if there are no organizations within the netizen's wallet or the netizen selects “None of the above

Else

10 Note Bonus Point Organization

9. Activate Create Datum

Perform Section D where the data type is organization (including the relationships that the netizen or purchasing organization has to this new organization).

10. Note Bonus Point Organization

Note the name of the organization that is to receive at least some of the bonus points.

11. Deal with Bonus Point Assignment

Perform

12 List Selected Organizations

13 Record Percentages

12. List Selected Organizations

Display a list of the selected organizations together with default percentages and invite the netizen to accept or to alter the percentages that define how the bonus points will be distributed among the organizations.

13. Record Percentages

Record for each selected organization the percentage of the bonus points that it is to receive for baskets used on this visit.

Section S: Deal with Carriage

Perform

1 Carriage Costs?

2 Deal with Transit Method Table, if the netizen clicks “Carriage costs”

3 Create Sub-deliveries, if all lines do not have the same journey duration

1. Carriage Costs?

Display button for “Carriage costs”. Invite the netizen to click the button.

2. Deal with Transit Method Table

Perform

3 Display Transit Method Table

4 Deal with Splitting, until the netizen clicks “No (more) order line splitting”

7 Record Amendments, if the netizen clicks “OK” to accept the Transit Method Table and any modifications she has made

3. Display Transit Method Table

The IAD sends to CATS the permitted transit methods for each order line within the delivery. CATS to provides for each transit method that is permitted by any line in the delivery, the duration from the fulfillment depot to destination region. Display the dispatch delay for the current sub-delivery. Display the order lines as the names of the rows in a table entitled “Transit Method Table”. Display the various journey durations as the names of the columns in the table. In the body of the table mark those cells that are permitted for each order line. Invite the netizen to remove the marks from all but one cell for each order line. She can do this quickly by selecting the cell she wants to remain marked in each row.

4. Deal with Splitting

Perform

5 Split any Order Line?

6 Display Two Lines

5. Split any Order Line?

Ask the netizen whether she wishes to split any of the lines in the Transit Method Table. Invite her to select a line that she wishes to split.

6. Display Two Lines

Perform §11 of Section O.

7. Record Amendments

Record any additional order lines. And record the journey duration for each order line.

8. Create Sub-deliveries

Group the order lines in the sub-delivery into smaller sub-deliveries, so that all members of a sub-delivery have the same journey duration. Record these new sub-deliveries and delete the original sub-delivery.

Section T: Deal with Payment Method

Perform

1 Deal with Bankcard, if the netizen selects “Bankcard”

Else

9 Deal with Organization Account

1. Deal with Bankcard

Perform

2 Deal with Bankcard, until authorized bankcard is presented

2. Deal with Bankcard

Perform

3 List All Bankcards

4 Which Sub-deliveries

5 Request Debit Authority

6 Deal with Result

3. List All Bankcards

Display the bankcard details held within the netizen's wallet.

4. Which Sub-deliveries

Ask the netizen to mark the sub-deliveries she wishes to pay for with the card she has just selected. Tell her that her account will not be debited until the goods are dispatched. Her account within her wallet will however be debited so that she can view her commitments.

5. Request Debit Authority

Send debit for the grand total for the selected sub-deliveries plus details for the bankcard selected to the Payment Authorization Server and receive reply.

6. Deal with Result

Perform

7 Note Bankcard Details, if the debit is authorized

Else

8 Not Authorized

7. Note Bankcard Details

Note the bankcard details against the selected sub-deliveries.

8. Not Authorized

Display a message telling the netizen that the card selected has not been authorized for the debit amount.

9. Deal with Organization Account

Perform

10 Request Account Confirmation

11 Deal with Result

10. Request My Account Confirmation

The IAD asks the current site server whether the organization the netizen is currently representing has an account with that site. Get the reply.

11. Deal with Result

Perform

11 Note Account Details, if the netizen has an account with the site

12 Not Authorized

12. Note Account Details

For the selected sub-deliveries note the account number and address supplied by the site. Ask the netizen to enter an official order number, if she wishes.

13. Not Authorized

Display a message telling the netizen that the organization she is authorized to represent does not have an account with the current site.

Section U: Deal with Payments

In the narrative below “dispatch” means the same as “sub-delivery”.

Perform

1 Deal with Dispatches, if the registry site receives a dispatch file from a member site

7 Debit Site Account, if a “Payment Received” notification is received from the site server by the registry server

8 Credit Customs, if customs for a country enters a sub-delivery number and import duty is to be paid via the Internet and it has not yet been paid

1. Deal with Dispatches

Perform

2 Deal with One Dispatch, until each dispatch has been processed

2. Deal with One Dispatch

Perform

3 Deal with Product Payment

6 Credit Insurer, if the dispatch is insured against loss in transit

3. Deal with Product Payment

Perform

4 Credit Site, if bankcard details are held for the dispatch

Else

5 Send Invoice

4. Credit Site

Credit Site with the price of the goods composing the dispatched sub-delivery less an agreed registry percentage plus carriage, packing, and sales tax (if any). Debit bankcard for the total amount due for the sub-delivery.

5. Send Invoice

Send an invoice for the dispatched sub-delivery to the netizen.

6. Credit Insurer

Credit the insurer and debit the site account with the premium amounts.

7. Debit Site Account

Debit the site account with an agreed registry percentage of the price of the goods within the sub-delivery.

8. Credit Customs

Credit the Customs and Excise department in the destination country with the amount of import tax due on the sub-delivery. Debit the site server for the same amount.

Section V: Deal with Gift Wrapping

Perform

1 Deal with One Wrapping Type, until the netizen clicks “No more gifts”

1. Deal with One Wrapping Type

Perform

2 Which Wrapping Type?

3 Whole Basket?

4 Deal with Line Selection, if netizen answers “No” to ‘Whole basket?’ question

5 Deal with Charge for One Line, until each selected order line has a gift wrap charge

2. Which Wrapping Type?

Ask the site to display (if they are not already doing so) the gift wrapping styles they offer each with a “Use this One” button.

3. Whole Basket?

Note the style identifier and the price per unit length for the selected style and perform §6 of Section O for gift wrap type selected.

4. Deal with Line Selection

Perform §7 of Section O for gift wrap type selected.

5. Deal with Charge for One Line

6 Calculate Charge

7 Accept Line?

8 Record Accepted Charge, if the netizen clicks “OK” to accept the displayed gift wrap charge

6. Calculate Charge

The items in the order line are each separately gift wrapped. Invite the netizen to fill in a gift tag for each item in the line. Multiply the gift wrap length required per item by the quantity in the selected order line to give gift wrap length. Multiply the price per unit length by the gift wrap length to give gift wrap charge.

Multiply the wrapping labor charge by the quantity in the selected order line to give labor charge. Add the labor charge to the gift wrap charge to give the total gift wrap charge. Display this total against the order line.

7. Accept Line?

Invite the netizen to click “OK” to accept this gift wrap charge for the current gift wrap style. (She can perform §1 in Section V instead of accepting the charge).

8. Record Accepted Charge

Record the accepted charge against the current order line.

1. The Flexible, Orienting, and Better Shopping Wallet for Netizens is a method that allows a person to store her wallet on a specified Internet server or else to store her wallet on that Internet access device or on a portable medium while maintaining complete version control.

2. The Flexible, Orienting, and Better Shopping Wallet for Netizens is a method that enables a person to build her order and delivery instructions within a wallet on her Internet access device while retrieving data from various servers and then supply them to a server.

3. In addition to (3) the said data can be recorded in said person's wallet.

4. In addition to (3) said person can select a journey duration for each item.

5. In addition to (3) said order can be divided by said wallet according to destination, dispatch delay, and journey duration of each item in said order.

6. In addition to (3) said wallet obtains carriage costs and sales tax from a server based on journey durations and maximum volume and weight allowed.

7. In addition to (6) said wallet determines by reference to said server any import duty payable by reference to destination and fulfillment depot of each said item.

8. In addition to (7) said wallet arranges for said duty to be paid automatically when said items arrive at country of destination.
